(19) United States
(12) Patent Application Publication
(10) Pub. No.: US 2025/0123585 A1
(43) Pub. Date: Apr. 17, 2025

(54) IMAGE FORMING APPARATUS

(71) Applicant: CANON KABUSHIKI KAISHA, Tokyo (JP)

(72) Inventors: KOHEI DENO, Ibaraki (JP); TAKAHIRO ITO, Chiba (JP); KOHEI MIZUGUCHI, Ibaraki (JP); TAKURO YOSHIKAWA, Chiba (JP); YUTA SUZUKI, Ibaraki (JP); YUKINOJO TODA, Saitama (JP); IKU SHIMIZU, Chiba (JP); YUYA HAMAJI, Chiba (JP)

(21) Appl. No.: 18/894,487

(22) Filed: Sep. 24, 2024

(30) Foreign Application Priority Data
Oct. 13, 2023 (JP) 2023-177814

(51) Int. Cl. G03G 15/00

(52) U.S. Cl. CPC G03G 15/6579; G03G 15/607; G03G 15/6552

(57) ABSTRACT

An image forming apparatus includes an apparatus body, an opening/closing unit, an image forming unit, a reversing unit configured to reverse the sheet, a detection unit configured to detect a position of the sheet in a sheet width direction orthogonal to a sheet conveyance direction, and a control unit configured to control the image forming unit based on a detection result of the detection unit. A conveyance path through which the sheet reversed by the reversing unit is conveyed toward the image forming unit is provided in the opening/closing unit. The detection unit is disposed on the conveyance path.

### BACKGROUND OF THE INVENTION

### Field of the Invention

The present invention relates to an image forming apparatus that forms an image on a sheet.

### Description of the Related Art

JP 2009-51579 A describes that an openable and closable double-sided unit is provided on a right side surface portion of an image forming apparatus, and a sheet conveyance path is opened by opening the double-sided unit when a user performs jam clearing.

In the configuration of the above literature, a position of a sheet in a sheet width direction is shifted while the sheet is conveyed through the double-sided unit that is an openable and closable unit, and thus, image position accuracy of an image formed on the sheet may be deteriorated.

### SUMMARY OF THE INVENTION

According to an aspect of the invention, an image forming apparatus includes an apparatus body, an opening/closing unit provided on a side surface portion of the apparatus body and configured to be opened and closed with respect to the apparatus body, an image forming unit configured to form an image on a sheet, a reversing unit configured to reverse the sheet having a first surface on which a first image is formed to form a second image on a second surface opposite to the first surface, a detection unit configured to detect a position of the sheet in a sheet width direction orthogonal to a sheet conveyance direction, and a control unit configured to control the image forming unit based on a detection result of the detection unit, wherein a conveyance path through which the sheet reversed by the reversing unit is conveyed toward the image forming unit is provided in the opening/closing unit, and the detection unit is disposed on the conveyance path.

Further features of the present invention will become apparent from the following description of exemplary embodiments with reference to the attached drawings.

### BRIEF DESCRIPTION OF THE DRAWINGS

FIG. 1 is a schematic view of an image forming apparatus according to a first embodiment.

FIG. 2 is a block diagram illustrating a control system according to the first embodiment.

FIG. 3 is an explanatory view of a contact image sensor (CIS) detection unit according to the first embodiment.

FIG. 4A is an explanatory view of a door unit according to the first embodiment.

FIG. 4B is an explanatory view of the door unit according to the first embodiment.

FIG. 4C is an explanatory view of the door unit according to the first embodiment.

FIG. 5A is an explanatory view of the door unit according to the first embodiment.

FIG. 5B is an explanatory view of the door unit according to the first embodiment.

FIG. 6 is plots and a timing chart illustrating control according to the first embodiment.

FIG. 7 is a flowchart illustrating control according to the first embodiment.

FIG. 8 is a schematic view of an image forming apparatus according to a second embodiment.

FIG. 9A is an explanatory view of a CIS detection unit according to the second embodiment.

FIG. 9B is an explanatory diagram of the CIS detection unit according to the second embodiment.

FIG. 9C is an explanatory diagram of the CIS detection unit according to the second embodiment.

FIG. 10 is plots and a timing chart illustrating control according to the second embodiment.

FIG. 11 is a flowchart illustrating control according to the second embodiment.

FIG. 12 is a graph illustrating a change in side end position according to the second embodiment.

FIG. 13A is a graph illustrating a change in image writing position according to the second embodiment.

FIG. 13B is a graph illustrating a change in image printing position according to the second embodiment.

### DESCRIPTION OF THE EMBODIMENTS

Hereinafter, embodiments according to the present disclosure will be described with reference to the drawings.

### First Embodiment

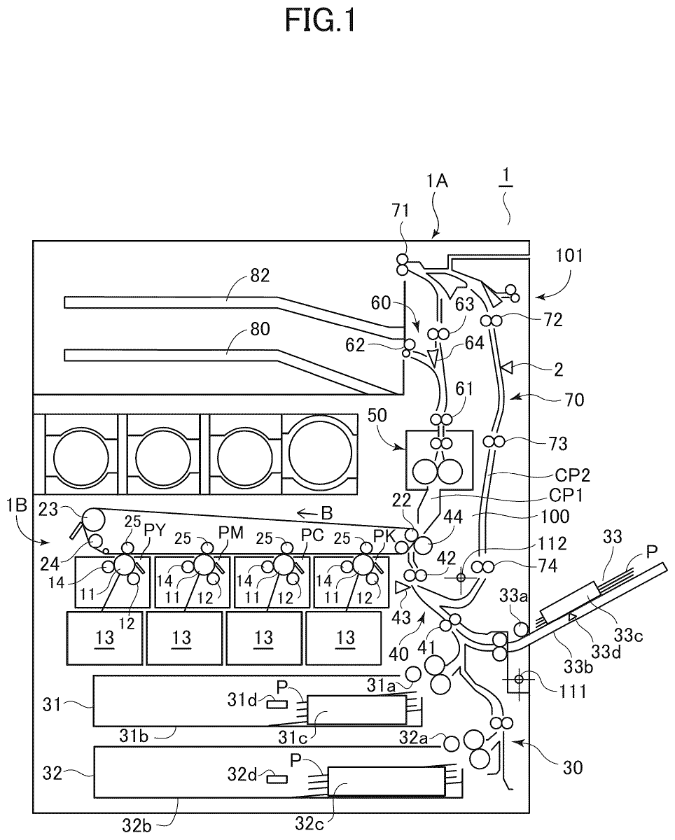

FIG. 1 is a schematic view of an image forming apparatus 1 according to a first embodiment. FIG. 1 illustrates a cross section of the image forming apparatus 1 when the image forming apparatus 1 is viewed from the front. The image forming apparatus 1 forms an image on a sheet P which is a recording material (recording medium). As the sheet P, various sheet materials having different sizes and materials, such as paper such as plain paper or thick paper, a sheet material subjected to surface treatment such as coated paper, a sheet material having a special shape such as an envelope or index paper, a plastic film, and cloth, can be used.

The image forming apparatus 1 is an electrophotographic color image forming apparatus. More specifically, the image forming apparatus 1 includes an intermediate transfer type/tandem type electrophotographic mechanism in which four process units PY, PM, PC, and PK are arranged along an intermediate transfer belt 21 which is an intermediate transfer member. The intermediate transfer type/tandem type is excellent in adaptability to a wide variety of recording materials, productivity (the number of printed sheets per unit time) of the image forming apparatus 1, and the like.

Hereinafter, a front side or viewer side of FIG. 1 (a front side of the image forming apparatus 1) is referred to as a “front side” or “apparatus front side”, and a back side or far side of FIG. 1 (a back side of the image forming apparatus 1) is referred to as a “back side” or “apparatus back side”.

### Image Forming Apparatus

As illustrated in FIG. 1, the image forming apparatus 1 includes an image forming unit 1B, a secondary transfer roller 44 serving as a transfer member, and a fixing device 50 serving as a fixing unit. The image forming unit 1B, the secondary transfer roller 44, and the fixing device 50 form the intermediate transfer type/tandem type electrophotographic mechanism.

The image forming unit 1B includes four process units PY, PM, PC, and PK, the intermediate transfer belt 21, a primary transfer roller 25, a secondary transfer inner roller 22, a drive roller 23, and a tension roller 24. The process units PY, PM, PC, and PK have substantially the same configuration except that colors of toners used for development are different. That is, each of the process units PY to PK includes a photosensitive drum 11 serving as an image bearing member (photosensitive member), a charging roller 12 serving as a charging unit, an exposure device 13 serving as an exposure unit, and a developing device 14 serving as a developing unit.

The intermediate transfer belt 21 is stretched around the secondary transfer inner roller 22, the drive roller 23, and the tension roller 24. The intermediate transfer belt 21 is rotated in a direction of an arrow B in the drawing by the drive roller 23 rotationally driven by a driving source. The tension roller 24 applies an appropriate tension to the intermediate transfer belt 21. The primary transfer roller 25 is disposed on an inner peripheral side of the intermediate transfer belt 21, and forms a primary transfer portion with the photosensitive drum 11.

The secondary transfer roller 44 is in contact with an outer peripheral surface of the intermediate transfer belt 21, and sandwiches the intermediate transfer belt 21 together with the secondary transfer inner roller 22. As a nip portion between the intermediate transfer belt 21 and the secondary transfer roller 44, a transfer portion (secondary transfer portion) at which a toner image is transferred to the sheet P is formed.

The fixing device 50 is an image heating device that heats the toner image on the sheet P to fix the toner image on the sheet P. The fixing device 50 includes, for example, a fixing roller (heating roller), a pressure roller that forms a nip portion (fixing nip) together with the fixing roller, and a halogen lamp serving as a heating unit that heats the fixing roller. The heating unit may be, for example, a ceramic heater in which a pattern of a heating resistor is printed on a ceramic substrate, or may be a coil unit for heating a conductive layer in the fixing roller by electromagnetic induction. Instead of the fixing roller, an endless (tubular) film or belt may be used as a fixing member.

The image forming apparatus 1 includes a sheet feeding unit 30 and a pre-transfer conveyance unit 40. The image forming apparatus 1 further includes a registration sensor 43, a discharge conveyance unit 60, discharge trays 80 and 82, and a duplex conveyance unit 70.

A sheet conveyance apparatus 100 of the present embodiment includes the sheet feeding unit 30, the pre-transfer conveyance unit 40, the discharge conveyance unit 60, the duplex conveyance unit 70, and elements involved in conveyance control for the sheet P in the conveyance units. The elements involved in the conveyance control for the sheet P include a motor that is a drive source of each conveyance unit, a sensor that detects a position of the sheet P on a conveyance path or a side end position of the sheet P, and the like.

The sheet feeding unit 30 is a conveyance unit that feeds the sheets P one by one toward the image forming unit 1B. The image forming apparatus 1 of the present embodiment includes cassette feeding units 31 and 32 and a manual feeding unit 33 as the sheet feeding unit 30.

The cassette feeding unit 31 includes a cassette 31b serving as a sheet loading portion (sheet container or sheet supporting portion) that stores the sheets P in a stacked state, and a feeding unit 31a serving as a feeding unit, and the cassette feeding unit 32 includes a cassette 32b serving as a sheet loading portion (sheet container or sheet supporting portion) that stores the sheets P in a stacked state, and a feeding unit 32a serving as a feeding unit. Each of the feeding units 31a and 32a includes, for example, a pickup roller provided on an upper side of the cassette 31b or 32b and a separation roller pair that separates and conveys the sheet P. The separation roller pair is a roller pair including a conveyance roller rotationally driven in a sheet feeding direction and a retard roller to which a driving force in a direction opposite to the sheet feeding direction is input via a torque limiter. The retard roller is an example of a separation member that separates the sheet P by a frictional force, and for example, a pad-like elastic member (separation pad) that comes into contact with the conveyance roller may be used as the separation member.

The manual feeding unit 33 includes a manual feed tray 33b (multi-purpose tray) serving as a sheet loading portion (sheet supporting portion) and a feeding unit 33a serving as a feeding unit. The manual feed tray 33b protrudes toward the outside of the image forming apparatus 1, so that the user can set the sheet P from the outside of the image forming apparatus 1. The feeding unit 33a can have the same configuration as that of the feeding units 31a and 32a of the cassette feeding units 31 and 32.

The cassettes 31b and 32b and the manual feed tray 33b (hereinafter, collectively referred to as the sheet loading portion) include a side regulating plate 31c and a size detection sensor 31d, a side regulating plate 32c and a size detection sensor 32d, and a side regulating plate 33c and a size detection sensor 33d, respectively.

The side regulating plates 31c, 32c, and 33c are regulating members that regulate an end position (sheet side end position) of the sheet P in a sheet width direction orthogonal to a sheet conveyance direction. The side regulating plates 31c, 32c, and 33c are a pair of regulating plates provided to be movable in the sheet width direction. The side regulating plates 31c, 32c, and 33c are moved according to the size of the sheet P set in the sheet loading portion to come in contact with a side end of the sheet P, and regulate the side end position of the sheet P.

The size detection sensors 31d, 32d, and 33d are detection units for detecting the size of the sheet P set in the sheet loading portion. The size detection sensors 31d, 32d, and 33d are sensors that detect the positions of the side regulating plates 31c, 32c, and 33c (FIG. 1) in the sheet width direction, for example. More specifically, as the size detection sensors 31d, 32d, and 33d, a variable resistor using a pinion of a rack and pinion mechanism that makes a pair of regulating plates move in conjunction with each other can be used.

The image forming apparatus 1 according to the present embodiment uses a center-based sheet conveyance method. The center-based sheet conveyance method is a method of conveying the sheet P such that a center position of the sheet P in the sheet width direction is aligned with a center position of a sheet conveyance path in the sheet width direction. In the side regulating plates 31c, 32c, and 33c provided in the sheet loading portions, the side regulating plate on one side and the side regulating plate on the other side in the sheet width direction move in conjunction with each other so as to maintain a symmetrical positional relationship with respect to the center position of the sheet conveyance path.

The pre-transfer conveyance unit 40 is a conveyance unit that conveys the sheet P fed from the sheet feeding unit 30 toward the secondary transfer portion. The pre-transfer conveyance unit 40 includes a pre-registration roller pair (hereinafter, referred to as a pre-registration roller pair 41) and a registration roller pair (hereinafter, referred to as a registration roller pair 42).

The discharge conveyance unit 60 is a conveyance unit that conveys the sheet P having passed through the fixing device 50 toward either the discharge tray 80 or 82 or the duplex conveyance unit 70. The discharge conveyance unit 60 includes conveyance roller pairs 61 and 63, a switching guide 64, and a discharge roller pair 62. The discharge roller pair 62 is an example of a discharge unit that discharges the sheet P to the outside of the image forming apparatus 1. In the present embodiment, a reverse conveyance roller pair 71 described below also functions as a discharge unit. The discharge trays 80 and 82 are stacking portions on which the sheets P serving as products are stacked.

The duplex conveyance unit 70 is a conveyance unit that reverses the sheet P having a first surface on which the image (first image) is formed by the image forming unit 1B and conveys (re-feeds) the sheet P toward the image forming unit 1B again when duplex printing is performed. The duplex conveyance unit 70 includes the reverse conveyance roller pair 71 and duplex conveyance roller pairs 72, 73, and 74 arranged along the sheet conveyance path. The reverse conveyance roller pair 71 is an example of a reversing unit that reverses the sheet P having the first surface on which the image (first image) is formed to form an image (second image) on a second surface opposite to the first surface.

A contact image sensor (CIS) detection unit 2 is disposed in the duplex conveyance unit 70. The CIS detection unit 2 is a detection unit that detects the position (in particular, the side end position of the sheet P) of the sheet P in the sheet width direction. The CIS detection unit 2 is a line sensor having a configuration of a contact image sensor. The CIS detection unit 2 includes a plurality of light receiving elements arranged in the sheet width direction, a light source that emits light toward the sheet P, a transparent member (reading glass) exposed to a duplex path CP2, and a lens array that forms a unit magnification optical system that guides reflected light from the sheet P to the plurality of light receiving elements. The CIS detection unit 2 emits light from the light source toward the duplex path CP2, and converts an optical image formed on the light receiving element via the reading glass and the lens array into an electrical signal.

A sheet conveyance path from the cassette feeding units 31 and 32 or the manual feeding unit 33 to the discharge roller pair 62 or the reverse conveyance roller pair 71 via the secondary transfer portion and the fixing device 50 is an image forming path CP1 on which an image is formed on the sheet P. A sheet conveyance path from the reverse conveyance roller pair 71 to the registration roller pair 42 via the duplex conveyance roller pairs 72, 73, and 74 is the duplex path CP2 that branches from the image forming path and joins the image forming path upstream of the secondary transfer portion. The reverse conveyance roller pair 71 can perform a reversing operation of switching back the sheet P conveyed through the image forming path and sending the sheet P to the duplex path CP2 and a discharging operation of discharging the sheet P conveyed through the image forming path to the discharge tray 82.

The image forming apparatus 1 of the present embodiment employs a configuration in which the image forming path CP1 extends in a substantially vertical direction through a side of the image forming unit 1B when viewed from a front side of an apparatus body (also referred to as a vertical conveyance type or a vertical pass type). The image forming path CP1 is a path through which the sheet P is conveyed upward, and the duplex path CP2 is a path through which the sheet P is conveyed downward. As a result, there is an advantage that an installation area of the image forming apparatus 1 can be reduced as compared with, for example, a configuration in which the image forming path CP1 extends in a substantially horizontal direction through below the image forming unit 1B (referred to as a horizontal conveyance type or a horizontal pass type). Further, as a door unit 101 described below is provided on a side surface portion of the image forming apparatus 1, the user can easily perform jam clearing.

### Image Forming Operation

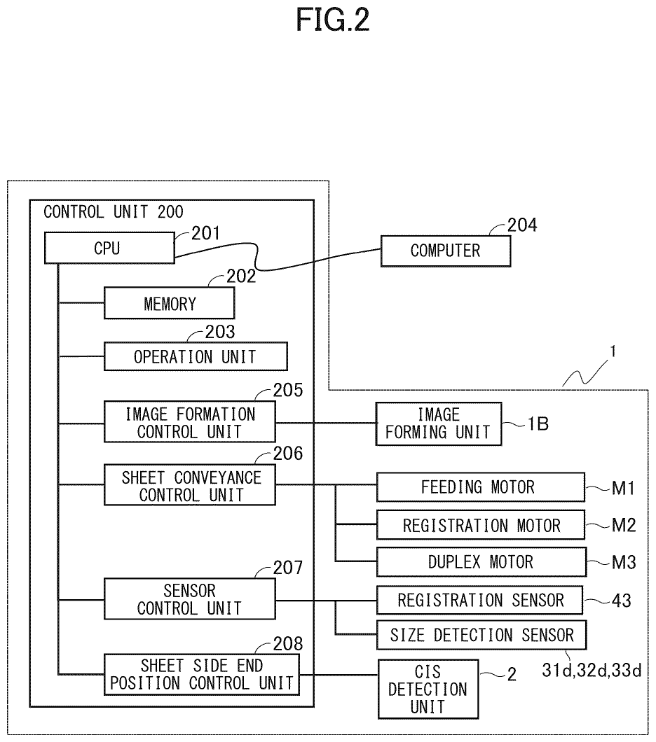

A control unit 200 (FIG. 2) of the image forming apparatus 1 performs a series of operations (an image forming operation and a printing operation) of forming an image on the sheet P based on image information according to an execution instruction from the user. The image information is input from, for example, an external computer connected to the image forming apparatus 1 via a network. In the present embodiment, as a mode (print mode) of the image forming operation, single-sided printing in which an image is formed on only one side of the sheet P and duplex printing in which images are formed on both sides of the sheet P can be switched.

When the image forming operation is started, the photosensitive drums 11 of the process units PY to PK and the intermediate transfer belt 21 are rotationally driven at a predetermined circumferential speed (process speed). The charging roller 12 uniformly charges the surface of each photosensitive drum 11. Each exposure device 13 is driven by a video signal generated based on the image information, irradiates the corresponding photosensitive drum 11 with light, and forms an electrostatic latent image on the surface of the photosensitive drum 11. The exposure device 13 may be a laser scanner using a laser beam or a light emitting diode (LED) exposure device using an LED as a light source. The developing device 14 supplies a developer containing the toner to the photosensitive drum 11 to develop the electrostatic latent image into a toner image. The toner image is primarily transferred from the photosensitive drum 11 to the intermediate transfer belt 21 by a pressurizing force and an electrostatic bias applied to the primary transfer portion by the primary transfer roller 25.

In the process units PY to PK, formation processes for the toner images of yellow, magenta, cyan, and black are performed in parallel. In addition, the formation processes are performed at a timing when the toner images of the respective colors overlap each other on the intermediate transfer belt 21. Therefore, a full-color toner image is formed on the intermediate transfer belt 21 while passing through four primary transfer portions. The full-color toner image is conveyed to the secondary transfer portion by the rotation of the intermediate transfer belt 21.

Meanwhile, the sheets P are fed one by one from one of the cassette feeding units 31 and 32 and the manual feeding unit 33. The fed sheet P is conveyed to the registration roller pair 42 via the pre-registration roller pair 41, and is subjected to skew feeding correction by the registration roller pair 42. Specifically, the pre-registration roller pair 41 conveys the sheet P by a predetermined distance to deflect (loop) the sheet P even after a leading edge of the sheet P comes into contact with a nip portion of the registration roller pair 42 that is stopped. As a result, the skew feeding correction of the sheet P is performed such that the leading edge of the sheet P follows the nip portion of the registration roller pair 42. The registration roller pair 42 conveys the sheet P to the secondary transfer portion according to a timing at which the toner image borne by the intermediate transfer belt 21 reaches the secondary transfer portion.

In the secondary transfer portion, the toner image is secondarily transferred from the intermediate transfer belt 21 to the sheet P by a pressurizing force and an electrostatic bias applied to the secondary transfer portion by the secondary transfer roller 44. The sheet P having passed through the secondary transfer portion is subjected to image fixing processing by the fixing device 50. The fixing device 50 fixes the toner image on the sheet P by heating and pressurizing the toner image on the sheet P while nipping the sheet P at the fixing nip and conveying the sheet P.

The sheet P having passed through the fixing device 50 is conveyed by the discharge conveyance unit 60. In the discharge conveyance unit 60, a conveyance path of the sheet P is switched the switching guide 64 depending on whether the mode of the image forming operation is the single-sided printing or the duplex printing.

In the case of the single-sided printing, when a discharge destination is set to the lower discharge tray 80, the sheet P is guided to the discharge roller pair 62 by the switching guide 64. The discharge roller pair 62 discharges the sheet P to the discharge tray 80. In the case of the single-sided printing, when the discharge destination is set to the upper discharge tray 82, the sheet P is guided to the reverse conveyance roller pair 71 by the switching guide 64. The reverse conveyance roller pair 71 discharges the sheet P to the discharge tray 82.

In the case of the duplex printing, the sheet P having the first surface on which the image (first image) is formed is guided to the reverse conveyance roller pair 71 by the switching guide 64. The reverse conveyance roller pair 71 performs a series of operations (switchback) of conveying the sheet P in a discharge direction, reversing the conveyance direction before a trailing edge of the sheet P in the discharge direction passes through the reverse conveyance roller pair 71, and conveying the sheet P toward the duplex path CP2. The sheet P switched back by the reverse conveyance roller pair 71 is conveyed through the duplex path CP2 by the duplex conveyance roller pairs 72, 73, and 74, and reaches the registration roller pair 42 again. Then, as the sheet P passes through the secondary transfer portion and the fixing nip again, an image (second image) is formed on the second surface of the sheet P opposite to the first surface. Thereafter, the sheet P is guided to the discharge roller pair 62 or the reverse conveyance roller pair 71 by the switching guide 64 depending on whether the discharge destination is the lower discharge tray 80 or the upper discharge tray 82, and is discharged by the discharge roller pair 62 or the reverse conveyance roller pair 71.

### Control System

Hereinafter, the control unit 200 of the image forming apparatus 1 will be described. The control unit 200 is a control unit that controls an operation of the image forming apparatus 1. In the present embodiment, the control unit 200 functions as a control unit that controls the image forming unit based on a detection result of the detection unit.

FIG. 2 is a block diagram illustrating the control unit 200 of the image forming apparatus 1. The control unit 200 includes a central processing unit (CPU) 201, a memory 202, an operation unit 203, an image formation control unit 205, a sheet conveyance control unit 206, a sensor control unit 207, and a sheet side end position control unit 208.

The CPU 201 operates the image forming apparatus 1 by executing a predetermined control program. The memory 202 is, for example, a random access memory (RAM), a read only memory (ROM), or the like, and stores various programs and various data in a predetermined storage area. The operation unit 203 receives various types of information (size information, grammage information, surface property information, and the like) related to a sheet used for printing by the user, and various types of operations performed by the user such as an instruction to perform or interrupt printing.

The image formation control unit 205 issues an instruction to the image forming unit 1B including the exposure device 13 to control a toner image forming process. The sheet conveyance control unit 206 issues an instruction to a feeding motor M1, a registration motor M2, a duplex motor M3, or the like to control conveyance of the sheet P. The feeding motor M1 is one or more motors that drive the feeding units 31a, 32a, and 33a. The registration motor M2 is a motor that drives the registration roller pair 42. The duplex motor M3 is a motor that drives the duplex conveyance unit 70.

The sensor control unit 207 controls the start and end of detection for various sensors such as the size detection sensors 31d, 32d, and 33d (FIG. 1) and the registration sensor 43, and receives detection results of the sensors.

The sheet side end position control unit 208 is connected to the CIS detection unit 2. The sheet side end position control unit 208 receives a detection signal of the CIS detection unit 2 and converts the detection signal into the side end position of the sheet P.

The control unit 200 can also be configured to be able to receive various types of information regarding the sheet used for the image forming operation from, for example, a computer (for example, a computer 204 illustrated in FIG. 2) connected via the network. The various types of information regarding the sheet include, for example, the size, grammage, and brand of the sheet P.

### Configuration of Detection of Sheet Side End Position

Hereinafter, a configuration for detecting the side end position of the sheet P in the sheet conveyance apparatus 100 according to the present embodiment and a specific configuration of the sheet conveyance apparatus 100 will be described.

The sheet P that is the recording material is stacked on the sheet loading portion (the cassette 31b or 32b or the manual feed tray 33b) for each size. In order to record an image in an appropriate range on the sheet P, it is required to cause the control unit 200 to recognize the size of the sheet P set in the sheet loading portion. In the present embodiment, the control unit 200 acquires the size of the sheet P set in each sheet loading portion based on information input by the user via the operation unit 203 or information acquired by the sensor control unit 207 from the size detection sensors 31d, 32d, and 33d.

The side end of the sheet P stacked in each sheet loading portion is regulated by the side regulating plate 31c, 32c, or 33c described above. In a state where the sheet P is stacked in each sheet loading portion, the side regulating plates 31c, 32c, and 33c suppress misalignment of the sheet P and skew feeding of the sheet P in the sheet width direction.

A gap may be generated between the side regulating plates 31c, 32c, and 33c and the sheet P due to a positioning error of the side regulating plates 31c, 32c, and 33c at the time of setting the sheet P, vibration of the apparatus accompanying the image forming operation, or the like. Due to the generated gap, there is a possibility that misalignment or skew feeding of the sheet P occurs when the sheet P is fed and conveyed.

However, a conveyance path length for the sheet P from the sheet loading portion to the secondary transfer portion is relatively short. For example, the cassettes 31b and 32b and the image forming unit 1B are in a positional relationship of vertically overlapping each other. Since the image forming path CP1 extends in the substantially vertical direction on one side of the cassettes 31b and 32b and the image forming unit 1B in the horizontal direction of FIG. 1, conveyance path lengths from the feeding units 31a and 32a to the secondary transfer portion are relatively short. In addition, since the manual feeding unit 33 is disposed on a side surface portion on a side on which the image forming path CP1 is provided in the horizontal direction of FIG. 1, a conveyance path length from the feeding unit 33a to the secondary transfer portion is relatively short. Therefore, the misalignment and skew feeding of the sheet P occurring during a period from when the sheet P is fed from the sheet loading portion to when the sheet P reaches the secondary transfer portion and the transfer of the toner image to the first surface of the sheet P is started are relatively small.

On the other hand, in the case of the duplex printing, the sheet P is switched back by the reverse conveyance roller pair 71 after passing through the secondary transfer portion for the first time, and is conveyed to the secondary transfer portion again via the duplex conveyance unit 70 and the registration roller pair 42. At this time, there is a possibility that misalignment or skew feeding of the sheet P occurs while the sheet P is switched back by the reverse conveyance roller pair 71. Since the reverse conveyance roller pair 71 nips the sheet P alone when switching back the sheet P, misalignment or skew feeding of the sheet P tend to easily occur as compared with a case where a plurality of conveyance roller pairs separated in the sheet conveyance direction simultaneously nip the sheet P. In addition, while the sheet P is conveyed from the reverse conveyance roller pair 71 to the registration roller pair 42 via the plurality of duplex conveyance roller pairs 72, 73, and 74, misalignment or skew feeding of the sheet P may occur. Since misalignment of the conveyance rollers causes the misalignment or skew feeding of the sheet P, the misalignment or skew feeding of the sheet P tend to easily occur as the sheet P is delivered and conveyed by a large number of conveyance roller pairs.

When the misalignment or skewing of the sheet P occurs during a period from when the sheet P passes through the secondary transfer portion for the first time to when the sheet P reaches the secondary transfer portion again, there is a possibility that image position accuracy on the second surface of the sheet P is lowered.

In addition, when the misalignment or skew feeding of the sheet P occurs during a period from when the sheet P passes through the secondary transfer portion for the first time to when the sheet P reaches the secondary transfer portion again, a difference in margin width from the side end of the sheet P to the image occurs between the image of the first surface and the image of the second surface formed by the duplex printing. In terms of quality of the product of the duplex printing, it is desirable that the difference in margin width between the first surface and the second surface is small.

As described above, in both the first surface and the second surface of the sheet P, there is a possibility that the image position accuracy is lowered due to the misalignment or skew feeding of the sheet P, but it is particularly required to improve the image position accuracy of the second surface rather than that of the first surface.

In the present embodiment, the image position accuracy on the second surface of the sheet P is improved using the CIS detection unit 2. As described above, the CIS detection unit 2 is disposed on the conveyance path (the duplex path CP2) of the duplex conveyance unit 70. In the present embodiment, in the sheet conveyance direction (arrow C) of the duplex conveyance unit 70, the CIS detection unit 2 is disposed between the most upstream duplex conveyance roller pair 72 and the second upstream duplex conveyance roller pair 73 (FIG. 1).

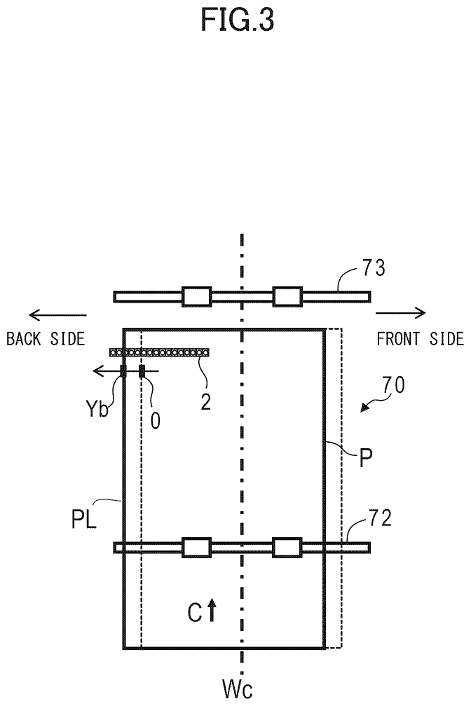

As illustrated in FIG. 3, the CIS detection unit 2 is disposed at a position biased to one side in the sheet width direction with respect to a center position Wc of the conveyance path (duplex path CP2) in the sheet width direction orthogonal to the sheet conveyance direction (arrow C). This is because it is sufficient if at least one side end position of the sheet P is detected to detect the position of the sheet P in the sheet width direction. In the present embodiment, the CIS detection unit 2 is disposed on the back side of the image forming apparatus 1. In this case, the control unit 200 can control the position of the image to be formed on the second surface of the sheet P with reference to a left side end PL when the sheet P is viewed in the sheet conveyance direction (arrow C).

The CIS detection unit 2 is disposed so as to be able to detect side end positions of a sheet P of a first size having a small width and a sheet P of a second size having a width larger than the first size among sheet sizes sufficient for the image forming apparatus 1 to form an image. The first size and the second size may be a size having the smallest width (minimum size) and a size having the largest width (maximum size) among the sheet sizes sufficient for the image forming apparatus 1 to form an image, respectively.

The control unit 200 calculates a deviation amount between a nominal position (a target position in design) of the side end PL of the sheet P and the actually detected position of the side end PL based on the detection result of the CIS detection unit 2. In the present embodiment, an image writing position when the exposure device 13 exposes the photosensitive drum 11 to form the image on the second surface of the sheet P is corrected based on the deviation amount. That is, the control unit 200 corrects the position of the image to be formed on the second surface of the sheet P based on the detection result of the CIS detection unit 2. As a result, the image position accuracy on the second surface of the sheet P can be improved.

### Door Unit

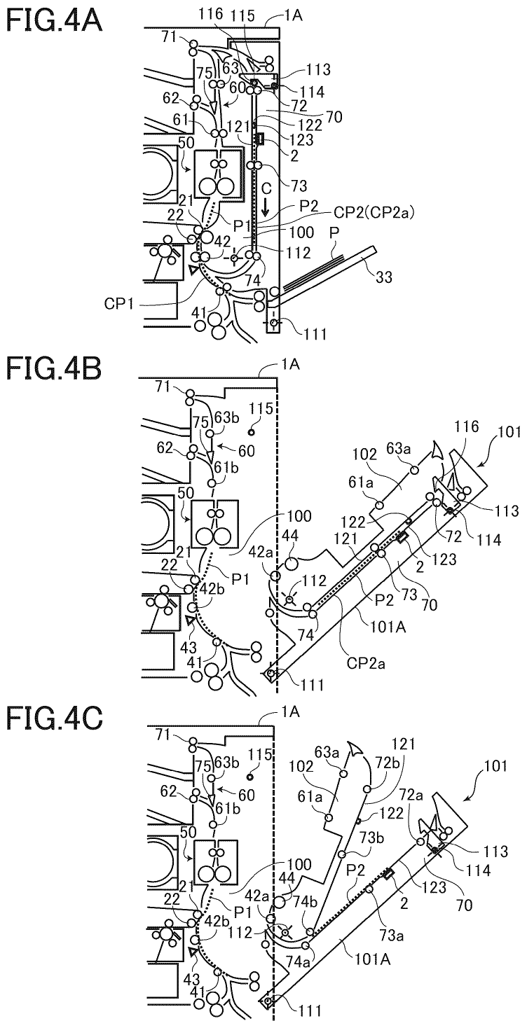

Next, the door unit 101 (right door) serving as an opening/closing unit provided on a side surface portion of an apparatus body 1A will be described. FIG. 4A is a cross-sectional view illustrating a part of the image forming apparatus 1 in a state where the door unit 101 is closed. FIG. 4B is a cross-sectional view illustrating a part of the image forming apparatus 1 in a state where the door unit 101 is opened. FIG. 4C is a cross-sectional view illustrating a part of the image forming apparatus 1 in a state where the door unit 101 is opened and an inner door 102 is opened. FIGS. 4A to 4C illustrate cross sections of the image forming apparatus 1 when viewed from the front side to the back side of the image forming apparatus 1 as in FIG. 1.

As illustrated in FIGS. 4A to 4C, the image forming apparatus 1 includes the apparatus body 1A (body frame or main casing) and the door unit 101 that is the opening/closing unit openable/closable with respect to the apparatus body 1A. The image forming unit 1B and the fixing device 50 described above are mainly disposed in the apparatus body 1A. The duplex conveyance unit 70 is mainly disposed in the door unit 101. The pre-transfer conveyance unit 40 and the discharge conveyance unit 60 are separately disposed in the apparatus body 1A and the door unit 101 for each element.

The door unit 101 can move to a closed position (FIG. 4A) and an open position (FIGS. 4B and 4C) by rotating around a rotation center 111 (hinge portion or support shaft portion). In the present embodiment, the rotation center 111 is provided at a lower end portion of the door unit 101 with reference to a posture when the door unit 101 is at the closed position. A rotation axis of the door unit 101 extends in the sheet width direction.

As illustrated in FIG. 4C, the door unit 101 includes an outer door 101A rotatably supported by the apparatus body 1A, and the inner door 102 rotatably supported by the outer door 101A. In other words, the opening/closing unit includes a first frame supported by the apparatus body, a second frame supported by the first unit so as to be openable and closable, and the conveyance roller pair that conveys the sheet via the conveyance path. The inner door 102 is movable to an inner door closed position (FIGS. 4A and 4B) and an inner door open position (FIG. 4C) with respect to the outer door 101A by rotating around a rotation center 112 (hinge portion or support shaft portion) in a state where the door unit 101 is at the open position. Arotation axis of the inner door 102 extends in the sheet width direction. That is, the rotation axis of the inner door 102 is parallel to the rotation axis of the door unit 101.

In a state where the door unit 101 is at the closed position, the outer door 101A forms a right side surface portion of the image forming apparatus 1 (an exterior surface on the right side when the image forming apparatus 1 is viewed from the front). In a state where the door unit 101 is at the closed position, the inner door 102 is housed in a space between the apparatus body 1A and the outer door 101A.

The outer door 101A includes a conveyance guide 123 that guides the second surface of the sheet P conveyed through the duplex path CP2. The inner door 102 includes a conveyance guide 121 that guides the first surface of the sheet P conveyed through the duplex path CP2. In a state where the door unit 101 is at the closed position (FIG. 4A) or in a state where the door unit 101 is at the open position and the inner door 102 is at the inner door closed position (FIG. 4B), at least a part of the duplex path CP2 is formed between the conveyance guides 121 and 123.

Hereinafter, a portion of the duplex path CP2 that is provided in the door unit 101 is referred to as an “in-door duplex path CP2a”. The entire duplex path CP2 may be the in-door duplex path CP2a.

In a state where the door unit 101 is at the open position and the inner door 102 is at the inner door open position (FIG. 4C), the conveyance guide 121 is separated from the conveyance guide 123, and the in-door duplex path CP2a is opened.

One roller 72a, 73a, or 74a of each duplex conveyance roller pair 72, 73, or 74 is disposed on the outer door 101A (FIG. 4C). The other roller 72b, 73b, or 74b of each duplex conveyance roller pair 72, 73, or 74 is disposed on the inner door 102. As illustrated in FIGS. 4A and 4B, in a state where the inner door 102 is not opened, one roller 72a, 73a, or 74a of the duplex conveyance roller pair 72, 73, or 74 is in contact with the other roller 72b, 73b, or 74b, so that the nip portion of each roller pair is formed. In a state where the inner door 102 is opened as illustrated in FIG. 4C, one roller 72a, 73a, or 74a of the duplex conveyance roller pair 72, 73, or 74 is separated from the other roller 72b, 73b, or 74b, so that the nip portion of each roller pair is released.

An urging member 125 (FIG. 4A) such as a spring member for pressurizing the nip portion of the duplex conveyance roller pair 72, 73, or 74 is disposed in at least one of the outer door 101A or the inner door 102. In FIG. 4A, the urging member 125 corresponding to one duplex conveyance roller pair 73 is illustrated, but the urging member 125 corresponding to the other duplex conveyance roller pair 73 is also provided. The urging member 125 urges the roller provided on one of the outer door 101A and the inner door 102 toward the roller provided on the other of the outer door 101A and the inner door 102 to pressurize the nip portion of the roller pair.

The inner door 102 of the present embodiment further includes a conveyance guide that guides the sheet P conveyed through the image forming path CP1, one roller 42a of the registration roller pair 42, the secondary transfer roller 44, and one rollers 61a and 63a of the conveyance roller pairs 61 and 63 (FIG. 4B). The other roller 42b of the registration roller pair 42 and the other rollers 61b and 63b of the conveyance roller pairs 61 and 63 are supported by the apparatus body 1A. The urging member 125 for pressurizing the nip portion of each roller pair (42, 61, or 63) is provided on at least one of the inner door 102 or the apparatus body 1A. The urging member 125 urges the roller provided on one of the inner door 102 and the apparatus body 1A toward the roller provided on the other of the inner door 102 and the apparatus body 1A to pressurize the nip portion of the roller pair.

In a state where the door unit 101 is closed, the roller (first roller) supported by the inner door 102 is pressed against the roller (second roller) supported by the apparatus body 1A due to an urging force of the urging member 125. In this way, the door unit 101 receives a force in a direction in which the door unit is to be opened from the apparatus body 1A.

In a state where the door unit 101 is at the closed position (FIG. 4A), the conveyance guide of the inner door 102 faces the conveyance guide of the apparatus body 1A to form the image forming path CP1. In a state where the door unit 101 is at the closed position (FIG. 4A), the secondary transfer roller 44 is in contact with the intermediate transfer belt 21 to form the secondary transfer portion. Further, in a state where the door unit 101 is at the closed position (FIG. 4A), one rollers 42a, 61a, and 63a and the other rollers 42b, 61b, and 63b of the registration roller pair 42 and the conveyance roller pairs 61 and 63 are in contact with each other, so that the nip portion of each roller pair is formed.

In a state where the door unit 101 is at the open position (FIGS. 4B and 4C), the conveyance guide of the inner door 102 is separated from the conveyance guide of the apparatus body 1A, and the image forming path CP1 is opened. In a state where the door unit 101 is at the open position (FIGS. 4B and 4C), the secondary transfer roller 44 is separated from the intermediate transfer belt 21, and the secondary transfer portion is released. In a state where the door unit 101 is at the open position (FIGS. 4B and 4C), the nip portions of the registration roller pair 42 and the conveyance roller pairs 61 and 63 are released.

When a conveyance abnormality (paper jam) of the sheet P occurs during execution of the image forming operation, and the image forming operation is stopped, the user can perform an operation of removing the sheet P staying in the image forming apparatus 1 (jam clearing) by opening the door unit 101. Specifically, FIG. 4A illustrates a state where paper jam occurs in a state in which a sheet P1 is nipped by the secondary transfer portion and the registration roller pair 42, and a sheet P2 is nipped by the duplex conveyance roller pair 73. The user can move the door unit 101 from the closed position to the open position as illustrated in FIG. 4B to release the secondary transfer portion and the nip portion of the registration roller pair 42 and remove the sheet P1. As illustrated in FIG. 4C, the user can further move the inner door 102 from the inner door closed position to the inner door open position to release the nip portions of the duplex conveyance roller pairs 72, 73, and 74 and remove the sheet P2.

In the present embodiment, as the door unit 101 is moved from the closed position to the open position, the nip portions of the plurality of roller pairs and the secondary transfer portion disposed on the image forming path CP1 are collectively released. Further, in the present embodiment, as the inner door 102 is moved from the inner door closed position to the inner door open position, the nip portions of the plurality of roller pairs disposed on the in-door duplex path CP2a are collectively released. Therefore, workability of jam clearing by the user can be improved.

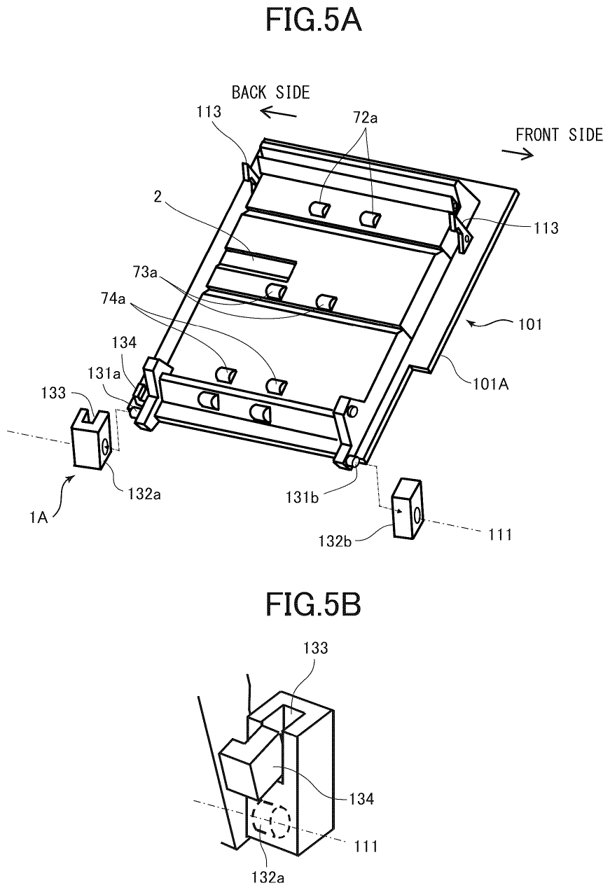

The image forming apparatus 1 includes a locking mechanism for locking the door unit 101 to the closed position. As illustrated in FIG. 4B, a hook 113 is provided on the door unit 101, and a fixed shaft 115 is provided on the apparatus body 1A. The hook 113 is rotatable around a hook shaft 114 extending substantially parallel to the sheet width direction. The hook 113 also has an engagement surface 116 that is engaged with the fixed shaft 115. The fixed shaft 115 is fixed to a frame member (sheet metal or the like) of the apparatus body 1A. One set of the hook 113 and the fixed shaft 115 is disposed on each of the front side and the back side of the image forming apparatus 1 (see also FIG. 5A). The two hooks 113 are connected to each other and rotate in conjunction with each other.

The hook 113 is connected to a grip portion provided on the outer door 101A via a link mechanism. When the user operates the handle portion, the hook 113 rotates around the hook shaft 114, so that engagement between the hook 113 and the fixed shaft 115 is released.

As illustrated in FIG. 4A, when the door unit 101 is at the closed position, the hook 113 serving as an engaging portion is engaged with the fixed shaft 115 serving as an engaged portion. In this case, the engagement surface 116 of the hook 113 is in contact with the fixed shaft 115, whereby the movement of the door unit 101 from the closed position to the open position is restricted. That is, the door unit 101 is locked to the closed position.

As described above, the urging member 125 for pressurizing the nip portion of each roller pair disposed on the in-door duplex path CP2a is disposed on at least one of the outer door 101A or the inner door 102. A force by which the rollers press each other at the nip portion of each roller pair is transmitted to a frame of the outer door 101A via a bearing portion of the roller on the outer door 101A. Therefore, when the door unit 101 is at the closed position, the outer door 101A continuously receives a force in a right direction in the drawing (a force for moving the door unit 101 from the closed position to the open position). When the engagement surface 116 comes into contact with the fixed shaft 115, the hook 113 and the fixed shaft 115 hold the door unit 101 at the closed position against a force that the door unit 101 receives due to the urging force of the urging member 125 for pressurizing the nip portion of the roller pair.

The fixed shaft 115 serving as the engaging portion may be disposed on the outer door 101A, and the rotatable hook 113 serving as the engaged portion may be disposed on the inner door 102.

### Relationship between Sheet Misalignment and Door Unit

As described above, the image forming apparatus 1 of the present embodiment includes the door unit 101 provided on the side surface portion of the apparatus body 1A so as to be openable and closable. With this configuration, the misalignment or skew feeding (collectively referred to as misalignment or the like) of the sheet P in the sheet width direction is likely to occur during a period from when the sheet P is reversed by the reverse conveyance roller pair 71 in the duplex printing to when the sheet P reaches the secondary transfer portion for the second time.

First, since the door unit 101 is openable and closable with respect to the apparatus body 1A, positional misalignment of the door unit 101 may occur due to backlash of a support mechanism (a hinge or the like) that enables the door unit 101 to move. For this reason, the misalignment or the like of the sheet P may occur while the sheet P is delivered and conveyed between the sheet conveyance path of the apparatus body 1A and the sheet conveyance path in the door unit 101.

Furthermore, as a reference example, a difference from the door unit 101 will be described using a horizontal conveyance type image forming apparatus in which a part of a duplex conveyance unit is configured as a pull-out unit that can be pulled out (slidable) to a front side of the apparatus in the image forming apparatus. In the reference example, the pull-out unit is pulled out and inserted in the sheet width direction, whereas the door unit 101 of the present embodiment is opened and closed in a direction in which the sheet conveyance path inside the image forming apparatus 1 is opened (a direction intersecting the sheet width direction and the sheet conveyance direction). That is, in the present embodiment, an opening/closing operation of the door unit 101 is performed so as to pressurize and separate the rollers of the conveyance roller pair disposed on the sheet conveyance path. The opening/closing operation of the door unit 101 here includes opening/closing of the inner door 102 in a state where the entire door unit 101 is opened.

For this reason, as compared with the pull-out unit of the reference example, a disruption in roller pressure balance of the conveyance roller pair, generatrix misalignment of the conveyance roller pair, a front-back difference of a guide gap, and the like tend to easily occur along with the opening and closing of the door unit 101. The disruption in roller pressure balance means that a nipping pressure for the sheet at the nip portion of the roller pair becomes uneven between one side and the other side in the sheet width direction. The generatrix misalignment of the conveyance roller pair means that parallelism between a rotation axis of one roller of the conveyance roller pair and a rotation axis of the other roller becomes low (misalignment) due to backlash of the bearing or the like. The front-back difference of the guide gap means that a gap width between the conveyance guides facing each other and forming the sheet conveyance path in the sheet width direction (a front-back direction of the apparatus) is different between one side and the other side in the sheet width direction.

In the present embodiment, a part of the image forming path CP1 and the duplex path CP2 can be opened by the opening/closing operation of the door unit 101. Therefore, as compared with the pull-out unit of the reference example that can open only a part of the duplex path, an opening/closing frequency of the door unit 101 becomes high, and each change described above associated with the opening/closing of the door unit 101 is likely to accumulate.

Due to these factors, in the configuration including the door unit 101, the misalignment or skew feeding of the sheet P in the sheet width direction is likely to occur during a period from when the sheet P is reversed by the reverse conveyance roller pair 71 to when the sheet P reaches the secondary transfer portion for the second time in the duplex printing.

In order to improve the image position accuracy on the second surface of the sheet P, it is conceivable to arrange the detection unit that detects the side end position of the sheet P somewhere in the conveyance path through which the sheet P reaches the secondary transfer portion for the second time, and correct the image writing position on the second surface based on the detection result. The vicinity of the reverse conveyance roller pair 71, the in-door duplex path CP2a, and the vicinity of the registration roller pair 42 can be considered as an arrangement location of the detection unit, for example, but in the present embodiment, the CIS detection unit 2 serving as the detection unit is disposed on the in-door duplex path CP2a. The reason is as follows.

First, in a case where the detection unit is disposed in the vicinity of the reverse conveyance roller pair 71, a conveyance path length through which the sheet P is conveyed from the detection unit to reach the secondary transfer portion for the second time via the duplex path CP2 becomes long. Therefore, an error between the side end position detected by the detection unit and the actual side end position when the sheet P reaches the secondary transfer portion for the second time tends to be large. In addition, since the reverse conveyance roller pair 71 nips the sheet P alone during switchback conveyance, the posture of the sheet P is difficult to be stabilized, which is disadvantageous in terms of detection accuracy for the side end position.

In addition, in a case where the detection unit is disposed in the vicinity of the registration roller pair 42, when the image writing position is to be changed using the detection result of the detection unit, productivity of the image forming apparatus 1 is deteriorated. That is, since the detection unit is close to the secondary transfer portion, when performing exposure at the image writing position corrected based on the detection result of the detection unit, the start of exposure is delayed until the sheet P reaches the detection unit.

On the other hand, as the CIS detection unit 2 serving as the detection unit is disposed on the in-door duplex path CP2a as in the present embodiment, it is possible to enhance the detection accuracy for the side end position as compared with a case where the detection unit is disposed in the vicinity of the reverse conveyance roller pair 71. In addition, it is possible to avoid deterioration in productivity of the image forming apparatus 1 by securing the conveyance path length from the detection unit to the secondary transfer portion.

### Positioning Configuration of CIS Detection Unit

A positioning configuration of the CIS detection unit 2 will be described. The CIS detection unit 2 is disposed on one of the conveyance guides 121 and 123 facing each other so as to form the duplex path CP2. In the present embodiment, the CIS detection unit 2 is disposed on the conveyance guide 123 of the outer door 101A.

In the present embodiment, the CIS detection unit 2 is disposed in the door unit 101. That is, the CIS detection unit 2 is disposed on the in-door duplex path CP2a in the door unit 101 which is the openable/closable opening/closing unit. For this reason, when the position of the CIS detection unit 2 is shifted due to the opening and closing of the door unit 101, an error may occur in the correction of the image position using the CIS detection unit 2, and the accuracy of the corrected image position may deteriorate.

In the door unit 101, a plurality of conveyance roller pairs (the duplex conveyance roller pairs 72, 73, and 74) are arranged along the in-door duplex path CP2a. When misalignment of the rollers occurs due to the configuration in which the door unit 101 is openable and closable, the misalignment and skew feeding of the sheet P occurring while the sheet P is conveyed through the in-door duplex path CP2a tend to increase. The misalignment of the rollers due to the configuration in which the door unit 101 is openable and closable includes, for example, backlash of a support portion (the rotation center 111) that rotatably supports the outer door 101A. In addition, since the door unit 101 is repeatedly opened and closed, the rotation center 111 and the locking mechanism (the hook 113 and the fixed shaft 115) are worn or deformed, and thus, the positioning accuracy when the door unit 101 is at the closed position may deteriorate.

Therefore, in the present embodiment, the positioning accuracy of the CIS detection unit 2 and the door unit 101 is improved by a configuration described below.

As illustrated in FIG. 4A, the CIS detection unit 2 is disposed between the rotation center 111 of the outer door 101A and the hook 113. That is, the CIS detection unit 2 is disposed between the rotation center of the door unit 101 and the engaging portion (the hook 113) for holding the door unit 101 at the closed position against the force caused by the urging force of the urging member 125 for pressurizing the nip portion of the roller pair. In other words, when viewed in the sheet width direction in a state where the door unit 101 is at the closed position, the CIS detection unit 2 is disposed between a position of the rotation center 111 and a position of the hook shaft 114 in a direction along a straight line connecting the rotation center 111 and the hook shaft 114.

A case where the CIS detection unit 2 is positioned farther from the rotation center 111 than the hook 113 will be described. In this case, a portion of the door unit 101 that is farther from the rotation center 111 than the hook 113 is slightly deformed rightward in FIG. 4A by the urging force of the urging member 125. For this reason, the position of the CIS detection unit 2 disposed on the outer door 101A is slightly moved in a direction away from the conveyance guide 121 of the facing inner door 102, and thus, there is a possibility that the position of the CIS detection unit 2 is shifted.

On the other hand, a portion of the door unit 101 that is closer to the rotation center 111 than the hook 113 is less likely to be deformed rightward in FIG. 4A due to the engagement between the hook 113 and the fixed shaft 115. In the present embodiment, since the CIS detection unit 2 is disposed between the rotation center 111 and the hook 113 of the outer door 101A, it is possible to suppress the positional misalignment of the CIS detection unit 2 due to the urging force of the urging member 125.

In the present embodiment, the CIS detection unit 2 is used as the detection unit that detects the side end position of the sheet P. However, it is known that the CIS has a shallow depth of field. An in-focus position of the CIS is often set near a reading surface (a front surface of the reading glass) of the CIS. Therefore, it is preferable that the sheet P to be read passes through a position that is in close contact with the reading surface of the CIS as much as possible. Meanwhile, a gap between the reading surface of the CIS detection unit 2 and the conveyance guide 121 facing the reading surface is set to about 2 to 3 mm in order to implement stable sheet conveyance regardless of a thickness of the sheet P or the like. Therefore, strictly speaking, the sheet P is allowed to pass through a position shifted from the in-focus position of the CIS detection unit 2.

When the gap between the reading surface of the CIS detection unit 2 and the conveyance guide 121 fluctuates, there is a possibility that the deviation of the sheet P from the in-focus position increases. In this case, the image acquired by the CIS detection unit 2 may be blurred, and an error of a result of detecting the side end position of the sheet P may increase. Therefore, it is desirable to minimize the fluctuation of the gap between the reading surface of the CIS detection unit 2 and the conveyance guide 121.

Therefore, in the present embodiment, a protrusion 122 is provided on at least one of the inner door 102 or the outer door 101A and comes into contact with the other of the inner door 102 or the outer door 101A, thereby stabilizing the gap between the reading surface of the CIS detection unit 2 and the conveyance guide 121. That is, the opening/closing unit includes a first conveyance guide and a second conveyance guide that forms the conveyance path with the first conveyance guide. The protrusion is provided on one of the first conveyance guide and the second conveyance guide, and is configured to come in contact with the other of the first conveyance guide and the second conveyance guide in a state where the opening/closing unit is closed. In the present embodiment, as illustrated in FIG. 4A, the protrusion 122 is provided on the conveyance guide 121 of the inner door 102.

In a state where the door unit 101 is at the closed position, the protrusion 122 is in contact with the conveyance guide 123 of the outer door 101A. As a result, the gap between the reading surface of the CIS detection unit 2 and the conveyance guide 121 is regulated with reference to a protruding height of the protrusion 122 from the conveyance guide 121. That is, the gap between the reading surface of the CIS detection unit 2 and the conveyance guide 121 can be stabilized in a configuration in which the conveyance guides 121 and 123 forming the in-door duplex path CP2a are opened and closed. Accordingly, the detection accuracy for the side end position of the sheet P can be improved.

In order to improve the detection accuracy, it is preferable that the protrusion 122 is disposed at a position close to the CIS detection unit 2. For example, the protrusion 122 is preferably disposed between the duplex conveyance roller pair 72 positioned upstream of the CIS detection unit 2 and the duplex conveyance roller pair 73 positioned downstream of the CIS detection unit 2 in the sheet conveyance direction (arrow C) on the in-door duplex path CP2a. In other words, the opening/closing unit includes a first conveyance roller pair disposed upstream of the detection unit in the sheet conveyance direction, and a second conveyance roller pair disposed downstream of the detection unit in the sheet conveyance direction on the conveyance path. The protrusion is disposed between the first conveyance roller pair and the second conveyance roller pair in the sheet conveyance direction.

A pressing force with which the protrusion 122 comes into contact with the conveyance guide 123 is determined by the sum of reaction forces received by the roller disposed on the inner door 102 from the roller disposed on the apparatus body 1A or the outer door 101A. The reaction force received by the roller 42a of the registration roller pair 42, the secondary transfer roller 44, and the rollers 61a and 63a of the conveyance roller pairs 61 and 63 from the rollers (42b, 22, 61b, and 63b) of the apparatus body 1A generates a moment in a clockwise direction of FIG. 4A around the rotation center 112. The reaction force received by the rollers 72b, 73b, and 74b of the duplex conveyance roller pairs 72, 73, and 74 from the rollers 72a, 73a, and 74a of the outer door 101A generates a moment in a counterclockwise direction of FIG. 4A around the rotation center 112. If the sum of the moment in the clockwise direction and the moment in the counterclockwise direction acting on the inner door 102 is in a direction (clockwise direction) in which the inner door 102 approaches the outer door 101A, the protrusion 122 can be stably brought into contact with the conveyance guide 123.

Next, a positioning configuration of the door unit 101 in the sheet width direction will be described with reference to FIGS. 5A and 5B. FIG. 5A is a perspective view illustrating the door unit 101 that is at the open position (the inner door 102 is at the inner door closed position) and a part of the apparatus body 1A. FIG. 5B is a perspective view illustrating a state where a projection 134 and a groove 133 described below are engaged with each other.

As illustrated in FIGS. 5A and 5B, shafts 131a and 131b are provided on the front side and the back side of the door unit 101. The shafts 131a and 131b are a part of the outer door 101A. A hole 132a into which the shaft 131a is fitted and a hole 132b into which the shaft 131b is fitted are provided in the apparatus body 1A. As the shafts 131a and 131b and the holes 132a and 132b are fitted, the door unit 101 is supported so as to be rotatable around the rotation center 111. The arrangement of the shaft and the arrangement of the hole can be interchanged, and the shaft may be provided in the apparatus body 1A and the hole may be provided in the door unit 101.

Further, a projection 134 is provided on the back side of the door unit 101. The projection 134 is provided at a position away from the rotation center 111 and is a protruding portion protruding in a direction intersecting the sheet width direction (a direction along an arc centered on the rotation center 111). The groove 133 that is a recessed portion to be engaged with the projection 134 is provided in the apparatus body 1A. An inner surface of the groove 133 faces both side surfaces of the projection 134 in the sheet width direction.

When the door unit 101 is at the closed position, the projection 134 is engaged with the groove 133. The engagement between the projection 134 and the groove 133 restricts positional misalignment of the door unit 101 with respect to the apparatus body 1A in the sheet width direction. That is, the positional misalignment of the door unit 101 with respect to the apparatus body 1A in the sheet width direction can be reduced to the size of the play between the projection 134 and the groove 133. Therefore, in a state where the door unit 101 is at the closed position, position accuracy of the CIS detection unit 2 in the sheet width direction can be improved. Accordingly, the detection accuracy for the side end position of the sheet P can be improved.

In addition, the projection 134 and the groove 133 are disposed on the back side of the image forming apparatus 1, similarly to the CIS detection unit 2. That is, the projection 134, the groove 133, and the CIS detection unit 2 are all disposed on the same side with respect to the center position Wc (FIG. 3) of the conveyance path in the sheet width direction (see also FIG. 5A). As a result, as compared with a case where the projection 134 and the groove 133, and the CIS detection unit 2 are disposed on opposite sides with the center position Wc interposed therebetween, the projection 134 and the groove 133, and the CIS detection unit 2 are less likely to be affected by intersecting components interposed therebetween. Therefore, the positioning accuracy of the CIS detection unit 2 can be further improved, and the detection accuracy for the side end position of the sheet P can be further improved.

### Control Example

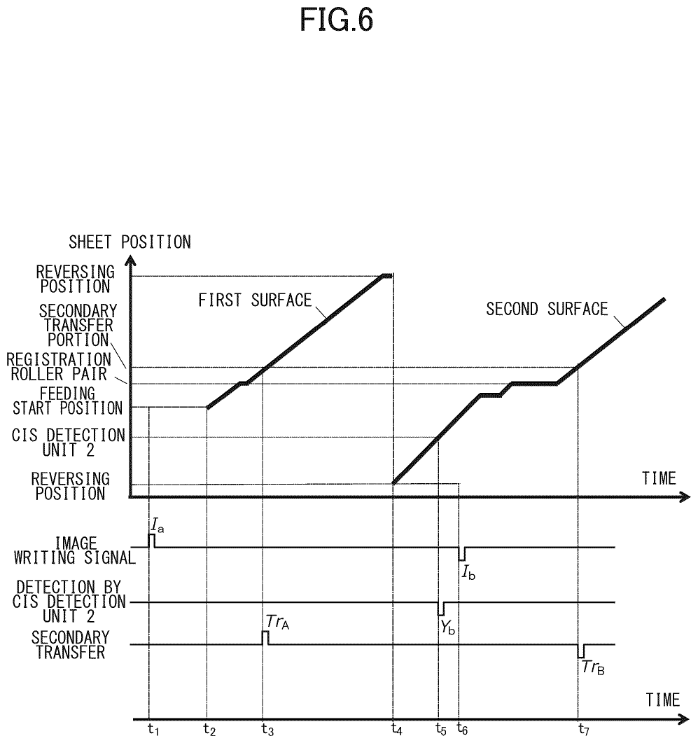

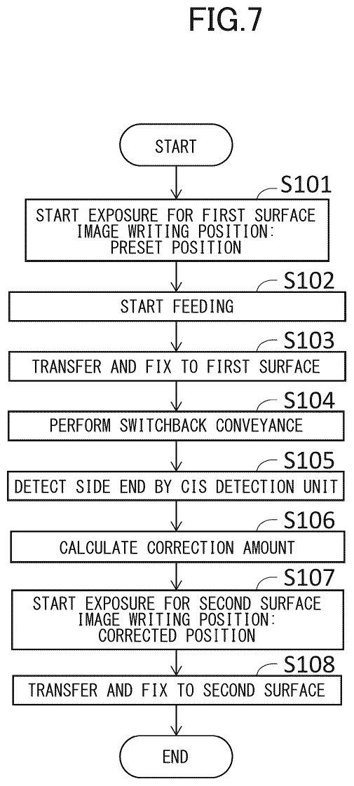

A method of controlling image position correction in the present embodiment will be described with reference to FIGS. 6 and 7. The upper part of FIG. 6 is a diagram illustrating a change in leading edge position of one sheet P during a job (continuous print job) in which the image forming operation is continuously performed on a plurality of sheets P. The lower part of FIG. 6 is a timing chart illustrating control timings related to conveyance of the sheet P. FIG. 7 is a flowchart illustrating a control content related to the sheet P of FIG. 6. Each step of this flow is performed by the CPU 201 of the control unit 200 (FIG. 2) reading and executing a program from the memory 202.

The vertical axis in the upper part of FIG. 6 represents the position on the conveyance path before the sheet P is reversed and the position on the conveyance path after the sheet P is reversed in an overlapping manner. The conveyance path before the sheet P is reversed is a conveyance path from the leading edge position (feeding start) of the sheet P set in the sheet loading portion to the reverse conveyance roller pair 71 through a feeding path and the image forming path CP1 (FIG. 1). The conveyance path after the sheet P is reversed is a conveyance path from the reverse conveyance roller pair 71 to the discharge roller pair 62 or the reverse conveyance roller pair 71 through the duplex path CP2 and the image forming path CP1. Since the leading edge of the sheet P is positioned at a downstream end of the sheet P in the sheet conveyance direction, the leading edge and the trailing edge of the sheet P are switched before and after the switching back by the reverse conveyance roller pair 71.

In the continuous print job, the processing illustrated in FIGS. 6 and 7 is repeatedly performed until image formation on the number of sheets P designated by the user is completed. In addition, a part of the processing for the preceding sheet and a part of the processing for the subsequent sheet may be performed in parallel.

First, the control unit 200 causes the image forming unit 1B to start exposure for forming an image on the first surface of the sheet P (time t1 in FIG. 6 and S101 in FIG. 7). Each exposure device 13 irradiates the corresponding photosensitive drum 11 with light based on an image writing signal transmitted from the image formation control unit 205 (FIG. 2) to write an electrostatic latent image on the corresponding photosensitive drum 11. In the present embodiment, before the feeding of the sheet P is started, the exposure of the photosensitive drum 11 is started in the most upstream process unit PY (FIG. 1) in a rotation direction of the intermediate transfer belt 21. Hereinafter, the photosensitive drum 11 of the process unit PY is referred to as the “most upstream photosensitive drum 11”.

In a main scanning direction of the photosensitive drum 11, a reference position of the electrostatic latent image to be written on the photosensitive drum 11 by the exposure device 13 is referred to as the “image writing position”. The control unit 200 can correct the image writing position by adjusting a timing of the image writing signal transmitted from the image formation control unit 205 to the exposure device 13. By correcting the image writing position, the position of the image with respect to the reference side end of the sheet P in the sheet width direction is corrected.

In the present embodiment, an image writing position Ia on the first surface is a preset position. Information regarding the image writing position Ia is stored in the memory 202 (FIG. 2) according to the size of the sheet P or the like, and is read by the CPU 201. The image writing position Ia is set in advance with reference to, for example, the nominal position of the side end PL of the sheet P.

In the present embodiment, the exposure of the most upstream photosensitive drum 11 is started before the feeding of the sheet P is started. Therefore, in the present embodiment, control of correcting the image writing position Ia on the first surface based on a first detection result Xa is not performed.

After the exposure of the most upstream photosensitive drum 11 is started, the feeding of the sheet P is started (time t2 in FIG. 6 and S102 in FIG. 7). When the sheet Preaches the secondary transfer portion, the transfer of the toner image from the intermediate transfer belt 21 to the first surface of the sheet P is started (time t3 in FIG. 6 and S103 in FIG. 7). Thereafter, the sheet P passes through the fixing device 50 to undergo toner image fixing processing. A length of the section (t1 to t3) is a time required for the toner image to reach the secondary transfer portion after the exposure of the most upstream photosensitive drum 11 is started. The feeding and conveyance of the sheet P are controlled such that the leading edge of the sheet P reaches the secondary transfer portion at time t3.

When the leading edge of the sheet Preaches the reverse conveyance roller pair 71, switchback conveyance is performed by the reverse conveyance roller pair 71 (S104 in FIG. 7). The reverse conveyance roller pair 71 reverses the rotation direction at a timing (time t4 in FIG. 6) when the leading edge of the sheet P in the sheet conveyance direction of the image forming path CP1 reaches a predetermined reversing position, and conveys the sheet P toward the duplex path CP2.

Thereafter, during the conveyance of the sheet P through the in-door duplex path CP2a, the CIS detection unit 2 detects the side end position of the sheet P (time t5 in FIG. 6 and S105 in FIG. 7). The sensor control unit 207 converts a detection signal (image signal) of the CIS detection unit 2 into the side end position of the sheet P, whereby the control unit 200 acquires the side end position of the sheet P.

The control unit 200 calculates a correction amount of the image writing position Ib on the second surface for the sheet P by using the side end position of the sheet P detected by the CIS detection unit 2 (S106 in FIG. 7). Then, the control unit 200 causes the image forming unit 1B to start exposure for forming an image on the second surface of the sheet P based on the corrected image writing position Ib (time t6 in FIG. 6 and S107 in FIG. 7). Thereafter, when the sheet P reaches the secondary transfer portion, the transfer of the toner image from the intermediate transfer belt 21 to the second surface of the sheet P is started (time t7 in FIG. 6 and S108 in FIG. 7), and the sheet P passes through the fixing device 50 to undergo the toner image fixing processing.

The timing (time t5) at which the CIS detection unit 2 detects the side end position of the sheet P is earlier than the timing (time t6) at which the exposure for forming the image on the second surface of the sheet P is started. Alength of the section (t6 to t7) is a time required for the toner image to reach the secondary transfer portion after the exposure of the most upstream photosensitive drum 11 is started. That is, the section (t1 to t3) for the first surface and the section (t6 to t7) for the second surface have the same time length.

The arrangement of the CIS detection unit 2 is set such that the side end position of the sheet P can be detected by the exposure start timing (time t6) which is a predetermined time before the transfer start timing (time t7). As a result, the control unit 200 can determine the correction amount of the image writing position Ib for the second surface of the sheet P based on the result of detecting the side end position of the sheet P by the CIS detection unit 2 for each sheet.

In FIG. 3, the nominal position of the side end PL of the sheet P is “0”, and a shift amount of the position of the side end PL detected by the CIS detection unit 2 with respect to the nominal position is Yb. In the present embodiment, with the image writing position Ia for the first surface as a reference, the image writing position Ib for the second surface is determined so as to be a position shifted in the same direction and the same distance as the shift amount (Yb) of the side end position (S106). In other words, the control unit determines the writing position based on a difference between the preset target position of the sheet and the position of the sheet detected by the detection unit. For example, in a case where the sheet P is shifted to the back side of the apparatus with respect to the nominal position as illustrated in FIG. 3, the image writing position Ib for the second surface is also shifted to the back side of the apparatus.

As described above, the misalignment or skew feeding of the sheet P is more likely to occur during a period from the first passage of the sheet P through the secondary transfer portion to the arrival of the sheet P at the secondary transfer portion again as compared with a period from the start of the feeding of the sheet P to the arrival of the sheet P at the secondary transfer portion. According to the present embodiment, by correcting the image writing position Ib for the second surface based on the detection result of the CIS detection unit 2, the position accuracy of the image formed on the second surface of the sheet P can be improved.

As described above, according to the present embodiment, the CIS detection unit 2 disposed on the in-door duplex path CP2a is provided in a configuration in which the in-door duplex path CP2a is provided in the door unit 101 openable and closable with respect to the apparatus body 1A of the image forming apparatus 1. In other words, a conveyance path for conveying the sheet reversed by the reversing unit toward the image forming unit is provided in the opening/closing unit, and the detection unit is disposed on the conveyance path. As a result, the image position accuracy on the second surface of the sheet P can be improved.

### Modified Example

In the description of the first embodiment, an example in which the image position is controlled with reference to the side end PL (the left side end in FIG. 3) of the sheet P on the back side of the apparatus, and the CIS detection unit 2 is disposed on the back side of the apparatus has been described. The present technology is not limited thereto, and for example, in a case where the image position is controlled with reference to the side end of the sheet P on the front side of the apparatus (the right side end in FIG. 3), the CIS detection unit 2 may be disposed on the front side of the apparatus. In this case, the same advantages as the above-described advantages can be expected by arranging the projection 134 and the groove 133 on the front side of the apparatus.

In the first embodiment, an example in which the CIS detection unit 2 is disposed downstream of the duplex conveyance roller pair 72 has been described, but the CIS detection unit 2 may be disposed upstream of the duplex conveyance roller pair 72 or downstream of the duplex conveyance roller pair 73, for example. The arrangement of the CIS detection unit 2 is determined such that the CIS detection unit 2 can detect the side end position of the sheet P before the exposure of the photosensitive drum 11 for forming the image on the second surface of the sheet P is started. The arrangement of the CIS detection unit 2 is determined in consideration of factors such as a path length from the exposure position of the most upstream photosensitive drum 11 to the secondary transfer portion, the process speed, a sheet conveyance speed in the duplex path CP2, and a stop time of the leading edge of the sheet in the registration roller pair 42.

A timing at which the CIS detection unit 2 detects the side end position of the sheet P may be a timing at which the leading edge of the sheet P reaches a detection position of the CIS detection unit 2, or may be a timing after the leading edge of the sheet P passes the detection position and is conveyed by a predetermined distance. In addition, the CIS detection unit 2 may detect the side end position of one sheet P a plurality of times, and acquire an average value of a plurality of pieces of side end position data as a detection result indicating the side end position of the sheet P.

In addition, the CIS detection unit 2 is an example of the detection unit that detects the position of the sheet P in the sheet width direction, and for example, a charge-coupled device (CCD) image sensor may be used. As the detection unit, a mechanism, in which a sensor (for example, a reflective photoelectric sensor) that detects the presence or absence of the sheet is moved in the sheet width direction by a motor, and the side end position of the sheet P is detected based on a driving amount of the motor, may be used.

In the first embodiment, a configuration in which the door unit 101 is supported so as to be rotatable around the rotation center 111 provided at a lower end portion of the outer door 101A has been described, but a support configuration of the door unit 101 is not limited thereto. For example, the door unit 101 may be supported by the apparatus body 1A such that the door unit 101 rotates around a rotation center provided at an end portion of the door unit 101 on the back side of the apparatus and extending in a substantially vertical direction. Further, as another example, the door unit 101 may be supported by the apparatus body 1A via a slide rail, and may be slidable in the horizontal direction in FIG. 1 along the slide rail. Also in these examples, the door unit 101 is movable between the closed position where the door unit 101 covers a side surface portion of the apparatus body 1A and the open position where a space is formed between the door unit 101 and the apparatus body 1A such that at least a part of the sheet conveyance path is opened.

The arrangement of the rollers in the door unit 101 and the apparatus body 1A is not limited to that described in the first embodiment. For example, the registration roller pair 42 and/or the secondary transfer roller 44 may be disposed in an additional opening/closing unit independent of the door unit 101, or may be disposed in the apparatus body 1A. In the former case, it is possible to release the nip portion of the registration roller pair 42 and/or the secondary transfer portion by opening the additional opening/closing unit after opening the door unit 101.

In a case where the registration roller pair 42 and/or the secondary transfer roller 44 are not disposed in the door unit 101, there are an advantage that positioning accuracy of the roller is not affected by positioning accuracy of the door unit 101 and an advantage that a nip pressure of the registration roller pair 42 or the secondary transfer portion can be increased. Such advantages also apply to the fixing device 50 that is not disposed in the door unit 101 in the present embodiment.

### Second Embodiment

As a second embodiment, a mode in which a registration roller pair 42 also includes a detection unit that detects a side end position of a sheet P in addition to a CIS detection unit 2 of a duplex conveyance unit 70 will be described. Hereinafter, elements denoted by reference numerals common to the first embodiment will have basically the same configurations and actions as those described in the first embodiment unless otherwise specified, and portions different from those of the first embodiment will be mainly described.

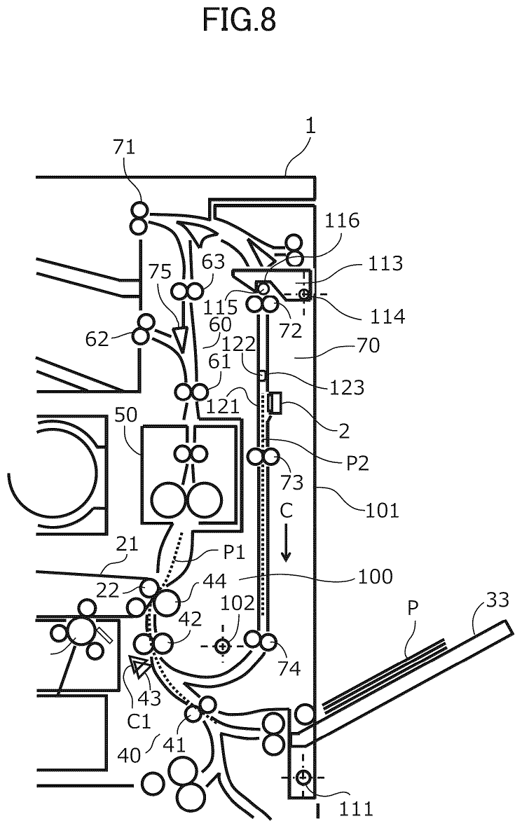

FIG. 8 is a cross-sectional view illustrating a part of an image forming apparatus 1 according to the second embodiment. As illustrated in FIG. 8, a CIS detection unit C1 is disposed in the vicinity of the registration roller pair 42. The CIS detection unit C1 is a line sensor having a configuration of a contact image sensor similarly to the CIS detection unit 2 disposed on an in-door duplex path CP2a. The CIS detection unit C1 is an example of a first detection unit disposed on a conveyance path from a sheet feeding unit 30 to an image forming unit 1B. The CIS detection unit 2 is an example of a second detection unit.

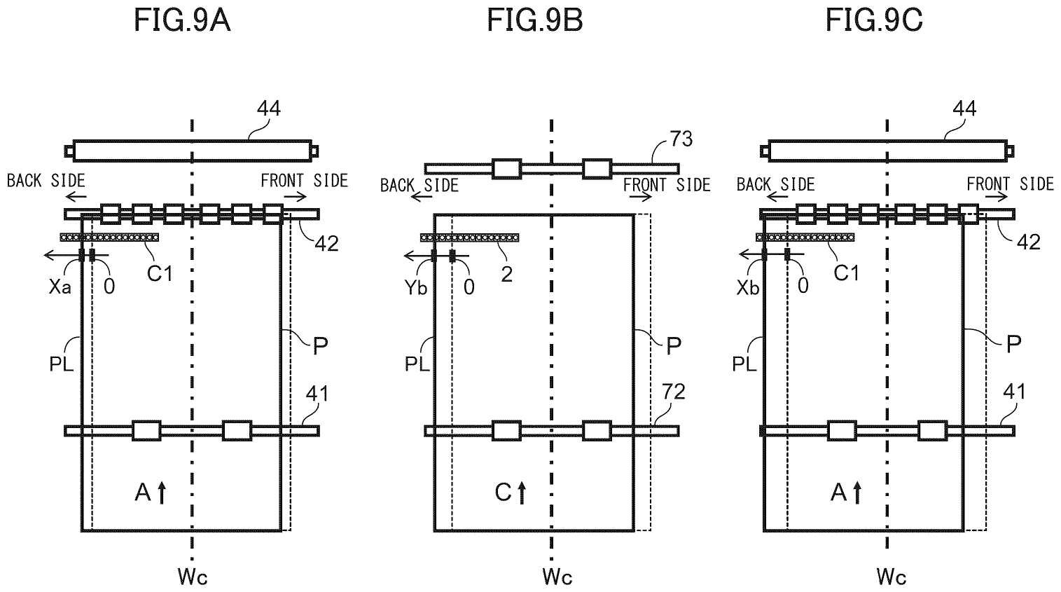

As illustrated in FIG. 9A, the CIS detection unit C1 detects a side end position of the sheet P before the sheet P fed from the sheet feeding unit 30 reaches a secondary transfer portion (secondary transfer roller 44). The side end position of the sheet P detected by the CIS detection unit C1 before the sheet P passes through the secondary transfer portion for the first time is a first detection result Xa. An arrow A indicates a sheet conveyance direction in an image forming path CP1.

As illustrated in FIG. 9B, the CIS detection unit 2 detects the side end position of the sheet P during the conveyance of the sheet P reversed by a reverse conveyance roller pair 71 through the in-door duplex path CP2a. The side end position of the sheet P detected by the CIS detection unit 2 before the sheet P reaches the secondary transfer portion again after passing through the secondary transfer portion for the first time is a second detection result Yb.

As illustrated in FIG. 9C, the CIS detection unit C1 detects the side end position of the sheet P before the sheet P conveyed through a duplex path CP2 reaches the secondary transfer portion (secondary transfer roller 44) again. The side end position of the sheet P detected by the CIS detection unit C1 before the sheet P passes through the secondary transfer portion for the second time is a third detection result Xb.

As described above, in the present embodiment, the side end position of one sheet P is acquired three times using the two CIS detection units C1 and 2.

The two CIS detection units C1 and 2 are disposed on the back side of the apparatus. That is, both of the two CIS detection units C1 and 2 are disposed on the same side with respect to a center position Wc of the conveyance path in the sheet width direction. As the two CIS detection units C1 and 2 are disposed on the same side in the sheet width direction, the same side end of the sheet P becomes a detection target, which is advantageous from the viewpoint of detection accuracy.

### Control Example

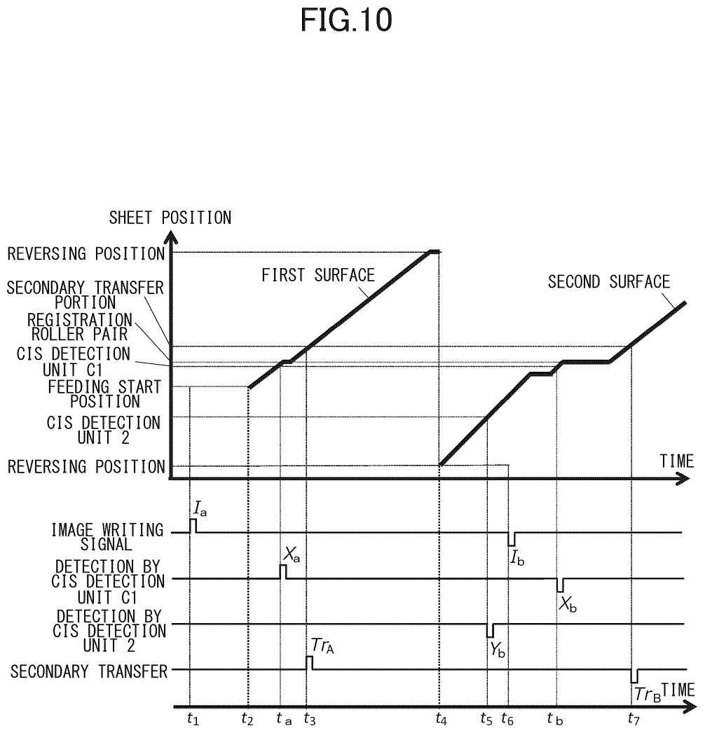

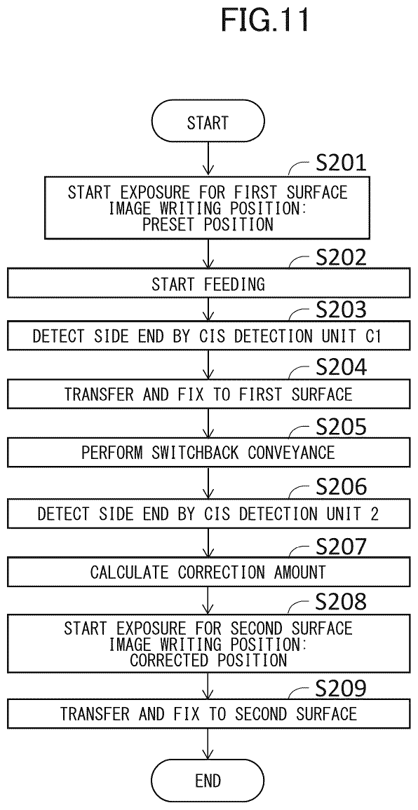

A method of controlling image position correction in the present embodiment will be described with reference to FIGS. 10 and 11. The upper part of FIG. 10 is a diagram illustrating a change in leading edge position of one sheet P in a continuous print job. The lower part of FIG. 10 is a timing chart illustrating control timings related to conveyance of the sheet P. FIG. 11 is a flowchart illustrating a control content related to the sheet P of FIG. 10. Each step of this flow is performed by a CPU 201 of a control unit 200 (FIG. 2) reading and executing a program from a memory 202.

First, the control unit 200 causes the image forming unit 1B to start exposure for forming an image on a first surface of the sheet P (time t1 in FIG. 10 and S201 in FIG. 11). Each exposure device 13 irradiates a corresponding photosensitive drum 11 with light based on an image writing signal transmitted from an image formation control unit 205 (FIG. 2) to write an electrostatic latent image on the corresponding photosensitive drum 11.

An image writing position Ia on the first surface is a preset position. Information regarding the image writing position Ia is stored in the memory 202 (FIG. 2) according to the size of the sheet P or the like, and is read by the CPU 201. The image writing position Ia is set in advance with reference to, for example, a nominal position of a side end PL of the sheet P. In the present embodiment, the exposure of the most upstream photosensitive drum 11 is started before the feeding of the sheet P is started. Therefore, in the present embodiment, control of correcting the image writing position Ia on the first surface based on a first detection result Xa is not performed. That is, the control unit determines the first writing position Ia based on a preset target position (nominal position) of the sheet regardless of the first detection result Xa.

After the exposure of the most upstream photosensitive drum 11 is started, the feeding of the sheet P is started (time t2 in FIG. 10 and S202 in FIG. 11). Thereafter, before the sheet P reaches the secondary transfer portion, the CIS detection unit C1 detects the side end position of the sheet P (time ta in FIG. 10 and S203 in FIG. 11). When the sheet Preaches the secondary transfer portion, the transfer of a toner image from an intermediate transfer belt 21 to the first surface of the sheet P is started (time t3 in FIG. 10 and S203 in FIG. 11). Thereafter, the sheet P passes through a fixing device 50 to undergo toner image fixing processing.

When a leading edge of the sheet P reaches the reverse conveyance roller pair 71, switchback conveyance is performed by the reverse conveyance roller pair 71 (S205 in FIG. 11). The reverse conveyance roller pair 71 reverses the rotation direction at a timing (time t4 in FIG. 10) when the leading edge of the sheet P in the sheet conveyance direction of the image forming path CP1 reaches a predetermined reversing position, and conveys the sheet P toward the duplex path CP2.

Thereafter, during the conveyance of the sheet P through the in-door duplex path CP2a, the CIS detection unit 2 detects the side end position of the sheet P (time t5 in FIG. 10 and S206 in FIG. 11).

The control unit 200 calculates a correction amount of an image writing position Ib on a second surface of the sheet P by using the side end position (the first detection result Xa and the second detection result Yb) of the sheet P detected by the CIS detection units C1 and 2 (S207 in FIG. 11). Then, the control unit 200 causes the image forming unit 1B to start exposure for forming an image on the second surface of the sheet P based on the corrected image writing position Ib (time t6 in FIG. 10 and S208 in FIG. 7).

Thereafter, before the sheet P reaches the secondary transfer portion again, the CIS detection unit C1 detects the side end position of the sheet P (time tb in FIG. 10). When the sheet P reaches the secondary transfer portion, the transfer of the toner image from the intermediate transfer belt 21 to the second surface of the sheet P is started (time t7 in FIG. 10 and S208 in FIG. 11), and the sheet P passes through the fixing device 50 to undergo the toner image fixing processing.

The timing of the first detection by the CIS detection unit C1 and the timing of the detection by the CIS detection unit 2 (times ta and t5) are earlier than the timing at which the exposure for forming the image on the second surface of the sheet P is started (time t6). Therefore, in the present embodiment, the first detection result Xa and the second detection result Yb are acquired for each sheet, and the image writing position Ib on the second surface is determined for the sheet P based on the first detection result Xa and the second detection result Yb.

In the present embodiment, the second detection (time tb) by the CIS detection unit C1 is performed after the exposure of the most upstream photosensitive drum 11 is started (time t6). Therefore, in the present embodiment, control of correcting the image writing position Ib on the second surface based on the third detection result Xb is not performed.

Furthermore, in FIG. 10, the control unit 200 performs standby processing of causing the sheet P to stand by upstream of the registration roller pair 42 between time t6 and time tb. This is to cause the sheet P to stand by when the exposure for forming an image cannot be started on the current sheet P whose side end position has been detected by the CIS detection unit 2, for example, in a case where an image forming operation is performed on another sheet in a continuous print job.

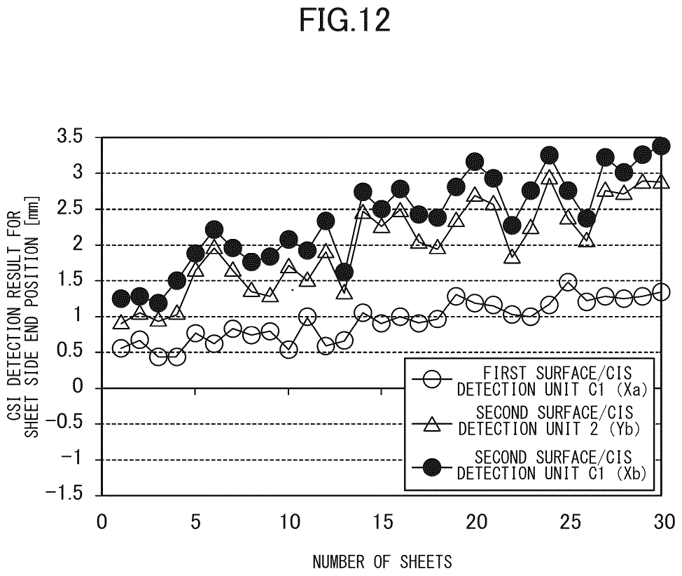

FIG. 12 is a graph illustrating a change of the first detection result Xa, the second detection result Yb, and the third detection result Xb for each sheet in a continuous print job in which duplex printing is performed on 30 sheets P.

A value of the first detection result Xa not only varies for each sheet, but also gradually increases during the continuous print job due to generation of a gap between a side regulating plate and the sheet P in each sheet loading portion.

A value of the second detection result Yb shows a change in which a variation for each sheet is added to the first detection result Xa. This is because misalignment of the sheet P and a shape error (a variation in orthogonality) of the sheet occurring while the reverse conveyance roller pair 71 independently nips the sheet P and performs the switchback conveyance are different for each sheet.

A value of the third detection result Xb shows a change in which the value is offset by a substantially constant value with respect to the second detection result Yb. It is known that a difference between the third detection result Xb and the second detection result Yb occurs in a conveyance process in the duplex conveyance unit 70 from a detection position of the CIS detection unit 2 to a detection position of the CIS detection unit C1.

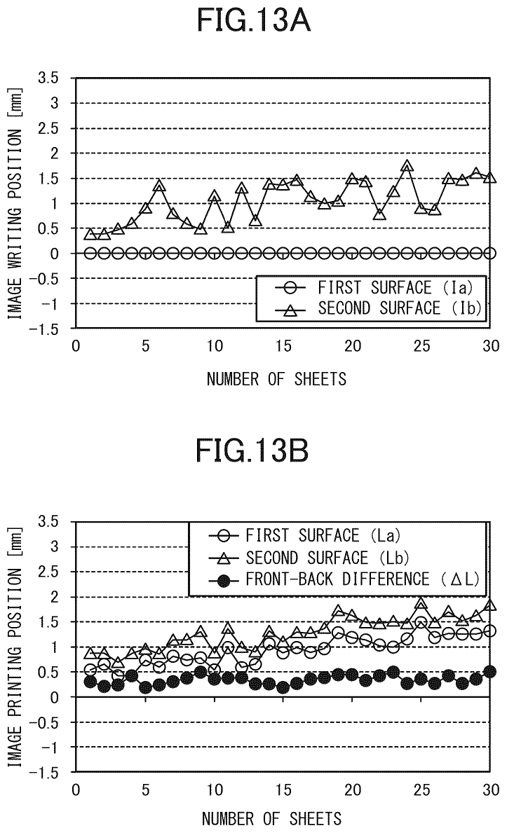

A method of determining the image writing position Ib on the second surface using the first detection result Xa and the second detection result Yb will be described in detail with reference to FIGS. 13A and 13B. The side end of the sheet P in the following description is a side end serving as a reference of the image position (the side end PL in FIG. 9A).

In the present embodiment, the image writing position Ia on the first surface is a preset position, and is fixed at 0 (mm), for example. On the other hand, the image writing position Ib on the second surface is calculated by the following equation.

$$Ib = Yb - Xa + Ia$$

In other words, in the present embodiment, a writing position at which the exposure unit writes an electrostatic latent image on the image bearing member to form an image (first image) on the first surface of the sheet is a first writing position (Ia). A writing position at which the exposure unit writes an electrostatic latent image on the image bearing member to form an image (second image) on the second surface of the sheet is a second writing position (Ib). The control unit determines the second writing position (Ib) based on the first writing position (Ia), the position (Xa) of the sheet detected by the first detection unit, and the position (Yb) of the sheet detected by the second detection unit.

FIG. 13A illustrates the changes of the image writing position Ia on the first surface and the image writing position Ib on the second surface for each sheet in the example of FIG. 12.

Next, when the first detection result Xa is regarded as being the same as the side end position of the sheet P when the toner image is transferred to the first surface of the sheet P, a position (an image printing position on the first surface) La of the image formed on the first surface of the sheet P with respect to the side end of the sheet P can be expressed by the following equation.

$$La = Xa - Ia$$

Similarly, when the third detection result Xb is regarded as being the same as the side end position of the sheet P when the toner image is transferred to the second surface of the sheet P, a position (an image printing position on the second surface) Lb of the image formed on the second surface of the sheet P with respect to the side end of the sheet P can be expressed by the following equation.

$$Lb = Xb - Ib = Xb - ( Yb - Xa + Ia )$$

A difference between the image printing position La on the first surface and the image printing position Lb on the second surface is defined as a front-back difference ΔL of the image. From the above equations of La and Lb, ΔL is expressed as follows.

$$Δ L = Lb - La = \{ Xb - ( Yb - Xa + Ia ) \} - \{ Xa - Ia \} = Xb - Yb$$

FIG. 13B illustrates the changes of the image printing position La on the first surface, the image printing position Lb on the second surface, and the front-back difference ΔL of the image in the example of FIG. 12.

As can be seen from the above result, according to the present embodiment, the front-back difference ΔL of the image in the duplex printing is substantially equal to the magnitude of the misalignment of the sheet P occurring on the conveyance path from the CIS detection unit 2 to the CIS detection unit C1. As can be seen from FIGS. 12 and 13B, the misalignment (Xb−Yb) of the sheet P occurring on the conveyance path from the CIS detection unit 2 to the CIS detection unit C1 is relatively small. Therefore, the front-back difference ΔL of the image can be effectively reduced by the method of the present embodiment in which the correction amount of the image writing position Ib on the second surface is determined based on the misalignment (Yb−Xa) of the sheet P occurring on the conveyance path from the CIS detection unit C1 to the CIS detection unit 2 without correcting the image writing position Ib on the first surface. In other words, the control unit of the present embodiment determines the second writing position (Ib) based on the difference (Yb−Xa) of the second detection result (Yb) from the first detection result (Xa) such that the difference (front-back difference ΔL) between the position of the image on the first surface with respect to the side end of the sheet and the position of the image on the second surface with respect to the side end in the sheet width direction approaches 0.

Preferably, as expressed by Equation Ib−Ia=Yb−Xa obtained by modifying the calculation equation for the second writing position (Ib), the control unit determines the second writing position (Ib) such that the difference (Ib−Ia) of the second writing position (Ib) from the first writing position (Ia) is equal to the difference (Yb−Xa) of the second detection result (Yb) from the first detection result (Xa). As a result, the front-back difference ΔL of the image can be more effectively reduced. However, if the second writing position (Ib) is determined such that at least a positive or negative sign of the difference (Ib−Ia) of the second writing position (Ib) from the first writing position (Ia) coincides with a sign of the difference (Yb−Xa) of the second detection result (Yb) from the first detection result (Xa), the front-back difference ΔL of the image can approach 0.

As described above, according to the present embodiment, image position accuracy at the time of the duplex printing can be further improved.

### Modified Example

In the example illustrated in FIGS. 13A and 13B, the image writing position Ib on the first surface is fixed to “0”, but the image writing position Ib may have a value other than 0. For example, before factory shipment, the image printing position La on the first surface when the image writing position Ib on the first surface is set to 0 may be measured, and the value of Ib determined such that the value of La approaches 0 may be stored in the memory 202. As a result, a tendency of the image printing position La on the first surface caused by an individual difference of the image forming apparatus 1 or the like can be improved.

In addition, in the example illustrated in FIGS. 13A and 13B, the misalignment (Xb−Yb) of the sheet P occurring on the conveyance path from the CIS detection unit 2 to the CIS detection unit C1 remains as the front-back difference ΔL of the image, but the front-back difference ΔL of the image may be canceled by adjustment before the factory shipment. That is, before the factory shipment, a continuous print job may be performed by the method of the present embodiment to acquire the value of the front-back difference ΔL of the image, and values of adjustment terms of the image writing positions Ia and Ib may be determined such that ΔL approaches 0 and stored in the memory 202. The adjustment terms are constants to be added to the calculation equations of the image writing positions Ia and Ib described in the present embodiment.

In the adjustment before the factory shipment, the value of Ib or the adjustment term may be stored in the memory 202 as a table value corresponding to information such as the type and size of the sheet P.

In the present embodiment, the first detection result Xa for a certain sheet P is not reflected on the image writing position Ia on the first surface of the sheet P. However, in the continuous print job, the first detection result Xa for the preceding sheet may be reflected on the image writing position Ia on the first surface of the subsequent sheet. For example, the image writing position Ia on the first surface of the subsequent sheet may be set to a value obtained by subtracting the first detection result Xa for the preceding sheet from the value described in the present embodiment. In addition, the image writing position Ib on the second surface may be calculated by the calculation equation of the present embodiment based on the image writing position Ia on the first surface calculated in this manner. As a result, the image position accuracy on the first surface and the second surface can be further improved.

### Other Examples

In the above-described embodiment, the control of performing detection by the CIS detection unit 2 for each sheet and correcting the image writing position Ib on the second surface of the sheet P based on the detection result has been described. Instead, for example, the image writing position on the first surface or the second surface of the subsequent sheet may be corrected using the detection result of the CIS detection unit 2 for the preceding sheet in the continuous print job. In addition, in a case where the detection result of the CIS detection unit 2 is equal to or more than a predetermined threshold, it may be determined that an image cannot be formed at an appropriate position with the correction of the image writing position, and the image forming operation may be interrupted.

According to the present disclosure, it is possible to provide an image forming apparatus capable of improving image position accuracy.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-177814, filed on Oct. 13, 2023, which is hereby incorporated by reference herein in its entirety.

What is claimed is:

1. An image forming apparatus comprising:
an apparatus body;
an opening/closing unit provided on a side surface portion of the apparatus body and configured to be opened and closed with respect to the apparatus body;
an image forming unit configured to form an image on a sheet;
a reversing unit configured to reverse the sheet having a first surface on which a first image is formed to form a second image on a second surface opposite to the first surface;
a detection unit configured to detect a position of the sheet in a sheet width direction orthogonal to a sheet conveyance direction; and
a control unit configured to control the image forming unit based on a detection result of the detection unit, wherein
a conveyance path through which the sheet reversed by the reversing unit is conveyed toward the image forming unit is provided in the opening/closing unit, and
the detection unit is disposed on the conveyance path.

2. The image forming apparatus according to claim 1, wherein
the image forming unit includes an image bearing member and an exposure unit configured to expose the image bearing member, and
the control unit is configured to determine a writing position at which the exposure unit writes an electrostatic latent image on the image bearing member to form the second image on the second surface of the sheet whose position has been detected by the detection unit based on the detection result of the detection unit.

3. The image forming apparatus according to claim 2, wherein
the control unit is configured to determine the writing position based on a difference between a preset target position of the sheet and the position of the sheet detected by the detection unit.

4. The image forming apparatus according to claim 2, further comprising:
a sheet feeding unit including a sheet supporting portion configured to support the sheet, the sheet feeding unit being configured to feed the sheet from the sheet supporting portion toward the image forming unit; and
a first detection unit disposed on a conveyance path from the sheet feeding unit toward the image forming unit and configured to detect a position of the sheet in the sheet width direction, wherein
the detection unit is a second detection unit, and
in a case where a position at which the exposure unit writes an electrostatic latent image on the image bearing member to form the first image on the first surface of the sheet is a first writing position, the writing position is a second writing position, the position of the sheet detected by the first detection unit before the first image is formed on the first surface is a first detection result, and the position of the sheet detected by the second detection unit is a second detection result, the control unit is configured to determine the second writing position based on the first writing position, the first detection result, and the second detection result.

5. The image forming apparatus according to claim 4, wherein
the control unit is configured to cause the exposure unit to start writing the electrostatic latent image on the image bearing member to form the first image on the first surface of the sheet before the first detection unit detects the sheet fed from the sheet feeding unit, and
the control unit is configured to determine the first writing position based on a preset target position of the sheet regardless of the first detection result.

6. The image forming apparatus according to claim 4, wherein
the control unit is configured to determine the second writing position based on a difference of the second detection result from the first detection result such that a difference between a position of the first image on the first surface with respect to a side end of the sheet in the sheet width direction and a position of the second image on the second surface with respect to the side end of the sheet approaches 0.

7. The image forming apparatus according to claim 4, wherein
the control unit is configured to determine the second writing position such that a difference of the second writing position from the first writing position is equal to a difference of the second detection result from the first detection result.

8. The image forming apparatus according to claim 4, further comprising:
a registration roller pair configured to convey the sheet fed from the sheet feeding unit to the image forming unit, wherein
the first detection unit is disposed upstream of the registration roller pair in the sheet conveyance direction, and
the control unit is configured to cause the sheet to stand by upstream of the registration roller pair in a case where exposure by the exposure unit is not started after the position of the sheet is detected by the detection unit.

9. The image forming apparatus according to claim 1, further comprising:
a sheet feeding unit including a sheet supporting portion configured to support the sheet, the sheet feeding unit being configured to feed the sheet from the sheet supporting portion toward the image forming unit, wherein
the image forming unit includes a plurality of image bearing members, an exposure unit configured to expose the plurality of image bearing members, and an intermediate transfer member to which toner images are transferred from the plurality of image bearing members, and
the control unit is configured to cause the exposure unit to start writing an electrostatic latent image for forming the first image on the first surface of the sheet on the most upstream image bearing member in a rotation direction of the intermediate transfer member among the plurality of image bearing members, and then cause the sheet feeding unit to start feeding the sheet.

10. The image forming apparatus according to claim 1, wherein
an image forming path is provided in the apparatus body, the image forming unit being configured to form the image on the sheet while the sheet is conveyed through the image forming path,
the image forming path is a path through which the sheet is conveyed upward, and
the conveyance path of the opening/closing unit is a path through which the sheet is conveyed downward.

11. The image forming apparatus according to claim 1, wherein
the opening/closing unit includes a first frame supported by the apparatus body, a second frame supported by the first frame so as to be openable and closable, and a conveyance roller pair configured to convey the sheet via the conveyance path, and
the conveyance roller pair includes a roller supported by the first frame and a roller supported by the second frame, and is configured such that a nip portion of the conveyance roller pair is released in a case where the second frame is opened with respect to the first frame.

12. The image forming apparatus according to claim 1, wherein
the opening/closing unit includes an engaging portion,
the apparatus body includes an engaged portion to be engaged with the engaging portion, and
the opening/closing unit is held at a closed position by engagement between the engaging portion and the engaged portion.

13. The image forming apparatus according to claim 12, wherein
the opening/closing unit is configured to rotate around a rotation axis with respect to the apparatus body, and
the detection unit is disposed between the rotation axis and the engaging portion.

14. The image forming apparatus according to claim 12, further comprising:
a conveyance roller pair including a first roller supported by the opening/closing unit and a second roller supported by the apparatus body, and configured to nip the sheet at a nip portion between the first roller and the second roller to convey the sheet; and
an urging member configured to urge one of the first roller and the second roller toward the other of the first roller and the second roller, wherein
in a case where the first roller is pressed against the second roller due to an urging force of the urging member in a state where the opening/closing unit is closed, the opening/closing unit receives a force in a direction in which the opening/closing unit is to be opened from the apparatus body.

15. The image forming apparatus according to claim 1, wherein
the opening/closing unit includes a first conveyance guide and a second conveyance guide that forms the conveyance path with the first conveyance guide,
the second conveyance guide is configured to move with respect to the first conveyance guide such that the conveyance path is opened, and
a protrusion is provided on one of the first conveyance guide and the second conveyance guide, and is configured to come in contact with the other of the first conveyance guide and the second in a state where the opening/closing unit is closed.

16. The image forming apparatus according to claim 15, wherein
the opening/closing unit includes a first conveyance roller pair disposed upstream of the detection unit in the sheet conveyance direction and a second conveyance roller pair disposed downstream of the detection unit in the sheet conveyance direction, and
the protrusion is disposed between the first conveyance roller pair and the second conveyance roller pair in the sheet conveyance direction.

17. The image forming apparatus according to claim 1, further comprising:
a protruding portion provided on one of the opening/closing unit and the apparatus body and protruding in a direction intersecting the sheet width direction; and
a recessed portion provided in the other of the opening/closing unit and the apparatus body and configured to be engaged with the protruding portion,
wherein in a state where the opening/closing unit is closed, movement of the opening/closing unit in the sheet width direction is restricted by engagement between the protruding portion and the recessed portion.

18. The image forming apparatus according to claim 17, wherein
the detection unit, the protruding portion, and the recessed portion are disposed on the same side with respect to a center position of the conveyance path in the sheet width direction.
